(19) United States
(12) Patent Application Publication
(10) Pub. No.: US 2022/0172090 A1
(43) Pub. Date: Jun. 2, 2022

(54) DATA IDENTIFICATION METHOD AND APPARATUS, AND DEVICE, AND READABLE STORAGE MEDIUM

(71) Applicant: TENCENT TECHNOLOGY (SHENZHEN) COMPANY LIMITED, Shenzhen (CN)

(72) Inventors: Qiaoling ZHENG, Shenzhen (CN); Zhilin SHI, Shenzhen (CN); Qiufang YING, Shenzhen (CN); Bin HU, Shenzhen (CN); Hao ZHANG, Shenzhen (CN); Jihong ZHANG, Shenzhen (CN)

(73) Assignee: TENCENT TECHNOLOGY (SHENZHEN) COMPANY LIMITED, Shenzhen (CN)

(21) Appl. No.: 17/672,814

(22) Filed: Feb. 16, 2022

Related U.S. Application Data
(63) Continuation of application No. PCT/CN2020/126055, filed on Nov. 3, 2020.

(30) Foreign Application Priority Data
Feb. 11, 2020 (CN) 202010086855.6

(51) Int. Cl. G06N 7/00; G06F 16/901; G06F 21/31; G06K 9/62

(52) U.S. Cl. CPC G06N 7/005; G06K 9/6215; G06F 21/316; G06F 16/9024

(57) ABSTRACT

A method for data identification includes determining a target user set from a plurality of users, the target user set comprising at least two users having a first social relationship, wherein a first closeness of the first social relationship among the at least two users in the target user set is higher than a second closeness of a second social relationship between users in the target user set and a user not in the target user set, acquiring a default abnormal user and determining abnormal users in the target user set based on the default abnormal user, determining the status of the target user set based on the abnormal users, and identifying a diffusion-abnormal user from to-be-confirmed users based on social relationships between abnormal users and the to-be-confirmed users in the target user set based on the status of the target user set being abnormal.

### CROSS REFERENCE TO RELATED APPLICATION(S)

This application is a continuation application of International Application No. PCT/CN2020/126055, filed on Nov. 3, 2020, which is based on and claims priority to Chinese Patent Application No. 202010086855.6, filed with the China National Intellectual Property Administration on Feb. 11, 2020, the entire contents of which are incorporated by reference herein.

### FIELD

This disclosure relates to the technical field of computers, and in particular, to a data identification method and apparatus, a device and a readable storage medium.

### BACKGROUND

In daily life, gambling and fraud incidents are common. In order to reduce the occurrence of such incidents, it is necessary to identify abnormal users efficiently and rapidly.

In the related art, the identification of the abnormal user is based on identification of behavior feature data of users. In a case that the behavior feature data of the user is consistent with behavior feature data of the abnormal user, the user is determined as the abnormal user. However, there may be the abnormal user that imitates the legal behavior of a normal user, so that behavior feature data corresponding to such abnormal users is closer to legal behavior feature data, which may cause the user who should be abnormal to be identified as the normal user. Therefore, the identification accuracy is not high.

### SUMMARY

Embodiments provide a data identification method and apparatus, a device, and a readable storage medium, so as to enhance the accuracy of data identification.

According to an aspect of example embodiments, a method performed by a computing device may include determining a target user set from a plurality of users, the target user set comprising at least two users having a first social relationship, wherein a first closeness of the first social relationship among the at least two users in the target user set is higher than a second closeness of a second social relationship between users in the target user set and a user not in the target user set, acquiring a default abnormal user and determining abnormal users in the target user set based on the default abnormal user, determining a status of the target user set based on the abnormal users, and identifying a diffusion-abnormal user from to-be-confirmed users based on social relationships between the abnormal users and the to-be-confirmed users in the target user set based on the status of the target user set being abnormal. The to-be-confirmed users may include users in the target user set other than the abnormal users.

According to an aspect of example embodiments, a data identification apparatus may include at least one memory configured to store computer program code and at least one processor configured to access said computer program code and operate as instructed by said computer program code, said computer program code including first determining code configured to cause the at least one processor to determine a target user set from a plurality of users, the target user set comprising at least two users having a first social relationship, wherein a first closeness of the first social relationship among the at least two users in the target user set is higher than a second closeness of a second social relationship between users in the target user set and a user not in the target user set, first acquiring code configured to cause the at least one processor to acquire a default abnormal user and determine abnormal users in the target user set based on the default abnormal user, second determining code configured to cause the at least one processor to determine a status of the target user set based on the abnormal users, and first identifying code configured to cause the at least one processor to identify a diffusion-abnormal user from to-be-confirmed users based on social relationships between the abnormal users and the to-be-confirmed users in the target user set based on the status of the target user set being abnormal. The to-be-confirmed users may include users in the target user set other than the abnormal users.

According to an aspect of example embodiments, a non-transitory computer-readable storage medium may store computer instructions that, when executed by at least one processor of a device, cause the at least one processor to determine a target user set from a plurality of users, the target user set comprising at least two users having a first social relationship, wherein a first closeness of the first social relationship among the at least two users in the target user set is higher than a second closeness of a second social relationship between users in the target user set and a user not in the target user set, acquire a default abnormal user and determine abnormal users in the target user set based on the default abnormal user, determine a status of the target user set based on the abnormal users, and identify a diffusion-abnormal user from to-be-confirmed users based on social relationships between the abnormal users and the to-be-confirmed users in the target user set based on the status of the target user set being abnormal. The to-be-confirmed users may include users in the target user set other than the abnormal users.

According to an aspect of example embodiments, a data identification apparatus is provided, including:

a target user set acquisition module, configured to acquire a target user set, the target user set including at least two users having a social relationship;

an abnormal user determination module, configured to acquire a default abnormal user, and determine abnormal users in the target user set according to the default abnormal user;

a behavior status detection module, configured to determine a status of the target user set according to the abnormal users; and

a diffusion-abnormal user identification module, configured to identify a diffusion-abnormal user from to-be-confirmed users according to social relationship between the abnormal users and the to-be-confirmed users in the target user set in a case that the status of the target user set is abnormal, the to-be-confirmed users being users in the target user set other than the abnormal users.

The abnormal user determination module includes:

an abnormal user determination unit, configured to match the users in the target user set with the default abnormal user, and determine, as the abnormal users in the target user set, users having a matching ratio reaching a matching threshold.

The behavior status detection module includes:

a total user quantity acquisition unit, configured to acquire a quantity of the abnormal users, and acquire a total quantity of the users in the target user set;

an anomaly concentration determination unit, configured to determine an anomaly concentration of the target user set according to the quantity of the abnormal users and the total quantity of the users in the target user set; and

a first status determination unit, configured to determine the status of the target user set as a normal state in a case that the anomaly concentration is less than a concentration threshold.

The first status determination unit is further configured to determine the status of the target user set as abnormal in a case that the anomaly concentration is greater than or equal to the concentration threshold.

The behavior status detection module includes:

a behavior feature acquisition unit, configured to acquire a user social behavior feature set, the user social behavior feature set including the social behavior feature of each user in a user group;

a feature distribution determination unit, configured to determine a first feature distribution of the abnormal users according to the social behavior features in the user social behavior feature set, the first feature distribution being used for representing a quantity of types of the social behavior features possessed by the abnormal users,

and further configured to determine a second feature distribution of the users in the target user set according to the social behavior features in the user social behavior feature set, the second feature distribution being used for representing a quantity of types of the social behavior features possessed by the users in the target user set;

a feature distribution difference determination unit, configured to determine a feature distribution difference between the abnormal user and the users in the target user set according to the first feature distribution and the second feature distribution; and

a second status determination unit, configured to determine the status of the target user set according to the first feature distribution and the feature distribution difference.

The second status determination unit is further configured to determine the status of the target user set as the normal state in a case that the feature distribution difference is less than a difference threshold and the first feature distribution is less than a distribution threshold.

The second status determination unit is further configured to determine the status of the target user set as the normal state in a case that the feature distribution difference is greater than or equal to the difference threshold and the first feature distribution is greater than or equal to the distribution threshold.

The second status determination unit is further configured to determine the status of the target user set as abnormal in a case that the feature distribution difference is greater than or equal to the difference threshold and the first feature distribution is less than the distribution threshold.

The target user set acquisition module includes:

a relationship topology graph acquisition unit, configured to acquire a relationship topology graph corresponding to a user group, the relationship topology graph including N nodes k, the N nodes k being in a one-to-one correspondence with users in the user group, N being a quantity of users in the user group, and an edge weight between two nodes k being determined based on a social relationship between two users in the user group;

a sampling path acquisition unit, configured to acquire sampling paths corresponding to the nodes k from the relationship topology graph according to a quantity of the sampling paths;

a jump probability determination unit, configured to determine a jump probability between the node k and an association node in the sampling path according to the edge weight in the relationship topology graph, the association node being a node in the sampling path other than the node k; and

a target user set determination unit, configured to update the relationship topology graph according to the jump probability to obtain an updated relationship topology graph, and determine the target user set in the updated relationship topology graph.

The relationship topology graph acquisition unit includes:

a user group acquisition subunit, configured to acquire a user group, each user in the user group being used as the node k;

a weight setting subunit, configured to perform edge connection between the nodes k corresponding to the users having the social relationship, and set an initial weight for an edge between the nodes k according to social behavior records among the users having the social relationship;

a probability transformation subunit, configured to perform probability transformation on the initial weight to obtain the edge weight; and

a relationship topology graph generation subunit, configured to generate the relationship topology graph according to the nodes k corresponding to the user group and the edge weight.

The jump probability determination unit includes:

an intermediate node acquisition subunit, configured to acquire an intermediate node between the node k and the association node from the sampling path in a case that there is no edge between the node k and the association node, the node k reaching the association node through the intermediate node;

a connection node pair determination subunit, configured to use, as a connection node pair, two nodes in the node k, the intermediate node, and the association node having an edge, and acquire an edge weight corresponding to the connection node pair; and

a jump probability determination subunit, configured to determine a jump probability between the node k and the association node according to the edge weight corresponding to the connection node pair.

The target user set determination unit includes:

a node edge updating subunit, configured to update a connected edge in the relationship topology graph according to the node k and the association node to obtain a transition relationship topology graph, the node k and the association node in the transition relationship topology graph being both connected with edges;

an edge weight setting subunit, configured to set the jump probability between the node k and the association node in the transition relationship topology graph as an edge weight between the node k and the association node to obtain a target relationship topology graph; and

a target user set determination subunit, configured to determine the target user set from the target relationship topology graph.

The target user set determination subunit is further configured to perform exponential growth on the jump probability, perform probability transformation on the jump probability obtained after the exponential growth to obtain a target probability, and update the edge weight between the node k and the association node according to the target probability.

The target user set determination subunit is further configured to determine, as a vital association node of the node k, the association node having the updated edge weight greater than a weight threshold.

The target user set determination subunit is further configured to divide the target relationship topology graph into at least two community topology graphs according to the node k and the vital association node, and acquire a target community topology graph from the at least two community topology graphs as the target user set.

The diffusion-abnormal user identification module includes:

a first related user determination unit, configured to determine, from the to-be-confirmed users, a user having a social relationship with the abnormal user in a case that the status of the target user set is abnormal; and

a first diffusion-abnormal user determination unit, configured to determine, as the diffusion-abnormal user, the user having the social relationship with the abnormal user.

The diffusion-abnormal user identification module includes:

a second related user determination unit, configured to determine, from the to-be-confirmed users, the user having the social relationship with the abnormal user in a case that the status of the target user set is abnormal; and

a second diffusion-abnormal user determination unit, configured to: acquire abnormal user nodes corresponding to the abnormal users, acquire association user nodes corresponding to the users having the social relationship with the abnormal users, determine, as a diffusion-abnormal node, the association user node having an edge weight with one of the abnormal user nodes greater than an association threshold, and determine the user corresponding to the diffusion-abnormal node as the diffusion-abnormal user.

The data identification apparatus further includes:

a to-be-identified user set determination module, configured to determine the target user set as abnormal as a to-be-identified user set;

a key text data extraction module, configured to acquire user text data of users in the to-be-identified user set, and extract key text data from the user text data;

a sensitive source data acquisition module, configured to acquire sensitive source data; and

an anomaly category determination module, configured to match the key text data with the sensitive source data, and determine an anomaly category of the to-be-identified user set according to a matching result.

According to an aspect of example embodiments, a computer device is provided and includes a processor and a memory.

The memory stores a computer program, the computer program, when executed by the processor, causing the processor to perform the method according to the embodiments of this application.

According to an aspect of example embodiments, a computer-readable storage medium is provided, the computer-readable storage medium storing a computer program. The computer program includes a program instruction. When the program instruction is executed by a processor, the method according to the embodiments of this application is performed.

### BRIEF DESCRIPTION OF THE DRAWINGS

In order to describe the technical solutions in the example embodiments of the disclosure more clearly, the following briefly describes the accompanying drawings for describing the example embodiments. Apparently, the accompanying drawings in the following description merely show some embodiments of the disclosure, and a person of ordinary skill in the art may still derive other accompanying drawings from these accompanying drawings without creative efforts.

FIG. 1 is a diagram of a network architecture according to an embodiment.

FIG. 2A is a diagram of a scenario for determining a diffusion-abnormal user according to an embodiment.

FIG. 2B is a diagram of a scenario for determining a diffusion-abnormal user according to an embodiment.

FIG. 3 is a flowchart of a data identification method according to an embodiment.

FIG. 4A is a diagram of a scenario for determining a status of a target user set according to an embodiment.

FIG. 4B is a diagram of a scenario for determining a status of a target user set according to an embodiment.

FIG. 5 is a diagram of a process for acquiring a target user set according to an embodiment.

FIG. 6A is a diagram of a node relationship list according to an embodiment.

FIG. 6B is a diagram of a node relationship according to an embodiment.

FIG. 6C is a diagram of a node relationship including an initial weight according to an embodiment.

FIG. 6D is a diagram of a relationship topology graph according to an embodiment.

FIG. 7 is a diagram of a scenario for dividing a community topology graph according to an embodiment.

FIG. 8 is a diagram of a process for determining an anomaly category of a target user set in an abnormal state according to an embodiment.

FIG. 9 is a structural diagram of a data identification apparatus according to an embodiment.

FIG. 10 is a structural diagram of a computer device according to an embodiment.

### DETAILED DESCRIPTION

The technical solutions in embodiments of this disclosure are clearly and completely described in the following with reference to the accompanying drawings in the embodiments of this disclosure. Apparently, the described embodiments are merely some rather than all of the embodiments of this disclosure. All other embodiments obtained by persons of ordinary skill in the art based on the embodiments of this disclosure without creative efforts shall fall within the protection scope of this disclosure.

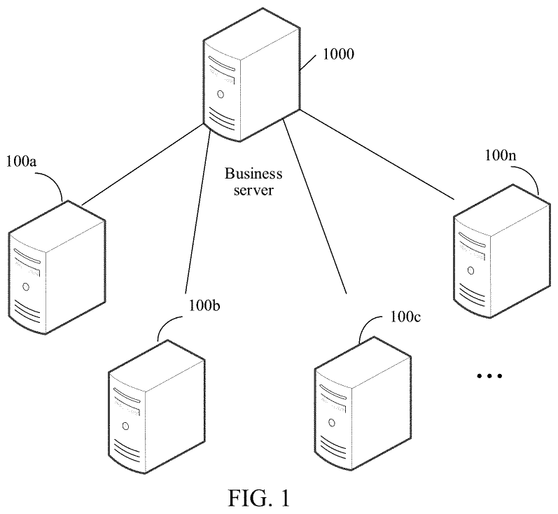

FIG. 1 is a diagram of a network architecture according to an embodiment. As shown in FIG. 1, the network architecture may include a business server 1000 and a back-end server cluster. The back-end server cluster may include a plurality of back-end servers. As shown in FIG. 1, the back-end servers may include, for example, a back-end server 100a, a back-end server 100b, a back-end server 100c, . . . , and a back-end server 100n. As shown in FIG. 1, the back-end server 100a, the back-end server 100b, the back-end server 100c, . . . , and the back-end server 100n may be respectively connected to the business server 1000 through a network, so that each back-end server may exchange data with the business server 1000 through the network. Therefore, the business server 1000 can receive business data from each back-end server.

As shown in FIG. 1, each back-end server corresponds to a user terminal, and may be configured to store business data of the corresponding user terminal. A target application may be integrated and installed on each user terminal. When the target application is operated in each user terminal, the back-end server corresponding to each user terminal may store the business data provided by the target application and exchange data with the business server 1000 shown in FIG. 1. The target application may include applications having a function of displaying data information such as texts, images, audios, videos, and the like. For example, the application may be a payment application. The payment application may be used for funds transfer between users, or may be a social application, such as an instant messaging application, which may be used for communication between the users. The business server 1000 in this disclosure may collect data from back ends (for example, the back-end server cluster) of the applications. For example, the data may be used for representing identification information of the users (for example, a user ID), transfer records between the users, communication logs between the users, and so on. According to the collected data, the business server 1000 may use the users in the data as user nodes in a community, and may further determine social relationships among the user nodes. Therefore, the social relationship in this disclosure, may refer to a relationship in which the users have any information transfer behavior during the use of the target application. The information transfer behavior, also referred to as a social behavior, includes but is not limited to at least one of the following: a transfer behavior of user information (for example, adding a user as a contact, following the user, and the like), a transfer behavior of content information (for example, instant chat, audio/video call, content forwarding, message leaving, message replying, and the like), a fund transaction relationship (for example, payment, transfer, and the like), or the like. During the implementation of the solutions of the embodiments, one or more of the various social behaviors or social relationships may be selected, according to factors such as the social functions provided by the target application, the data to be identified, and the like, as the basis for identifying data in the solutions.

The method of the embodiments may be performed by one or more computing devices, such as one or more computing devices in the business server 1000 shown in FIG. 1 and the back-end server cluster. The computing device may divide a user group into at least two user sets (hereinafter also referred to as a community) according to social relationships and social behavior records among the users in the user group. For example, the computing device may divide the users into a plurality of user sets according to the collected social behaviors among a large quantity of users, so that the social relationship between a first user and a second user in the user set to which the first user belongs is closer than the social relationship between the first user and users in other user sets. The computing device may identify an abnormal user from each user set according to existing abnormal user samples, and determine whether the user set is in a normal state or in an abnormal state according to the abnormal user in each user set. In a case that the user set is in the abnormal state, the computing device determines diffusion-abnormal users in the user set according to the social relationships between the abnormal users in the user set and other users in the user set.

In the embodiments of this disclosure, one of the plurality of user terminals may be selected as a target user terminal. The target user terminal may include intelligent terminals having functions of displaying and playing data information, such as a smart phone, a tablet computer, a desktop computer, and the like. For example, in the embodiments of this disclosure, the user terminal corresponding to the back-end server 100a shown in FIG. 1 is used as the target user terminal. The target user terminal may be integrated with the target application. In this case, the back-end server 100a corresponding to the target user terminal may exchange data with the business server 1000. For example, during the use of various applications in the user terminal by the large quantity of the users, the business server 1000 may detect and collect the social relationships among the large quantity of the users by using the back-end server. For example, there are communication logs between a user A and a user B, the business server 1000 may determine that there is a social relationship between the user A and the user B, and the social relationship is a communication relationship. After the large quantity of the users are detected and the social relationships among the users are determined, the business server 1000 may use the large quantity of the users as the user group. Each user in the user group is used as a node, and an edge connection is performed between the nodes corresponding to the users having the social relationship. Edge weights are set for the edges among the nodes according to the social behavior records among the users having the social relationships. A relationship topology graph may be generated according to the user group and the edge weights. According to the edge weight among the nodes, the relationship topology graph is divided into at least two different community topology graphs. The business server 1000 may divide the user group into at least two communities according to the social relationships and the social behavior records among the users in the user group. Next, the business server 1000 may identify the abnormal user from the community according to the existing abnormal user samples. The business server 1000 may determine whether the community is in the normal state or in the abnormal state according to the abnormal user in each community. If the community is in the abnormal state, the business server 1000 may acquire the abnormal user in the abnormal community. The business server 1000 may determine the diffusion-abnormal user from the normal users in the abnormal community according to the social relationships between the abnormal users in the abnormal community and normal users in the abnormal community. An objective of determining the diffusion-abnormal user is to identify a larger range of abnormal users. Because the abnormal user samples detected in advance may have a small sample size and a low coverage of the abnormal users, the coverage of the abnormal users identified from the abnormal community according to the abnormal user samples is small, and some of the abnormal users are not identified. Therefore, in order to enhance the accuracy of identification and expand the coverage, the diffusion-abnormal user may be determined according to the social relationships among the abnormal users that have been identified from the abnormal community.

By using an example of determining the diffusion-abnormal user from the community topology graph, the business server 1000 may adopt the following implementations for determining the diffusion-abnormal user. The business server 1000 may select one community topology graph from the divided community topology graphs as the target user set. The target user set includes at least two users having a social relationship. The business server 1000 may acquire a default abnormal user (that is, the existing abnormal user sample). According to the default abnormal user, the business server 1000 may determine the abnormal users in the target user set. The business server 1000 may detect the status of the target user set according to the quantity of the abnormal users and the total quantity of the users in the target user set. When the target user set is in the abnormal state, the business server 1000 may identify the diffusion-abnormal user from to-be-confirmed users according to the social relationships between the abnormal users and the to-be-confirmed users in the target user set, and use the diffusion-abnormal user as the abnormal user. The to-be-confirmed users are users in the target user set other than the abnormal users. After the abnormal user (including the diffusion-abnormal user) in each relationship topology graph is determined, the business server 1000 may generate an identification result according to the abnormal user in each relationship topology graph, and return the identification result to the back-end server.

In some embodiments, the back-end server may determine the large quantity of the users corresponding to the respective user terminal as the user group. Different community topology graphs are divided according to the user group to obtain different user sets. The abnormal users and the diffusion-abnormal users are identified in the user sets. For the implementation herein that the back-end server identifies the abnormal users and the diffusion-abnormal users, reference may be made to the description that the business server identifies the abnormal users and the diffusion-abnormal users.

The method provided in the embodiments of this disclosure may be performed by a computer device. The computer device includes, but is not limited to, a terminal or a server.

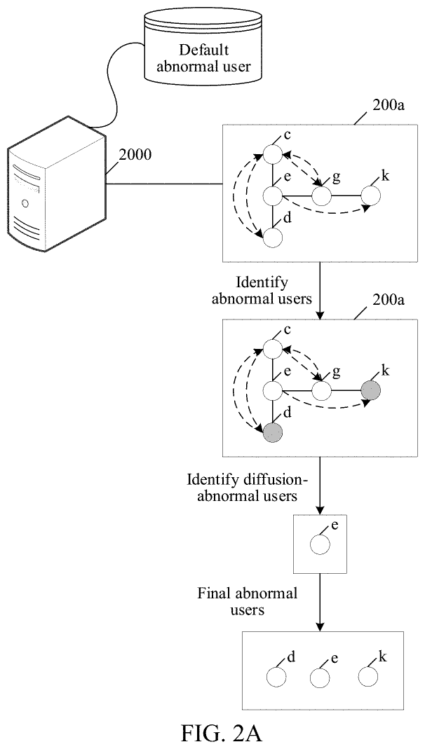

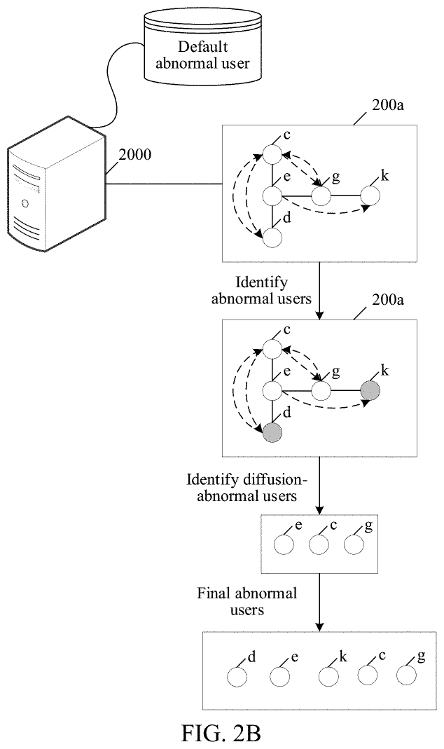

FIG. 2A is a diagram of a scenario for determining a diffusion-abnormal user according to an embodiment. As shown in FIG. 2A, a target user set 200a is used as an example. A business server 2000 may acquire an existing default abnormal user (that is, an existing abnormal user sample), match the default abnormal user with a user corresponding to a node in the target user set 200a, and use the users having a matching ratio reaching a matching threshold as abnormal users. For example, the matching ratio of a user d and a user k in the target user set 200a to the default abnormal user is greater than the matching threshold, the user d and the user k may be identified as the abnormal users. Then, a total quantity of the users in the target user set 200a is 5 (user c+user e+user d+user g+user k), and a quantity of the abnormal users is 2 (the abnormal user d and the abnormal user k). According to the total quantity of the users being 5 and the quantity of the abnormal users being 2, an anomaly concentration of the target user set 200a may be determined as 40%, which is greater than 30% of a concentration threshold. Then, the business server 2000 may determine a status of the target user set 200a as the abnormal state, that is, the target user set 200a is an abnormal community. Subsequently, a diffusion-abnormal user may be determined from the abnormal target user set 200a according to a social relationship (that is, whether there are edges in the target user set 200a) between the abnormal user d and the abnormal user k. For example, there is an edge between the user d and the user e, and an edge weight of the user d and the user e is 0.8, which is greater than an association threshold of 0.75, which may indicate that the user e and the abnormal user d have a strong relationship. There is a large probability that the user e is also an abnormal user, and the user e may be identified as the diffusion-abnormal user. There is also an edge between the user d and the user c, but an edge weight between the user d and the user c is 0.56. It may be determined that, 0.56 is far less than the association threshold of 0.75, which may indicate that although there is a social relationship between the user d and the user c, the correlation is very low. There is a small probability that the user c is an abnormal user, and the user c may be identified as the normal user. Similarly, if there is an edge between the user k and the user g, but an edge weight between the user k and the user g is 0.5, and 0.5 is far less than the association threshold of 0.75, the user g may be identified as the normal user. There is an edge between the user k and the user e, but the edge is not the edge from the user k to the user e, and it may be understood that the user k cannot reach the user e. For the user k, the user e is the normal user, but for the user d, the user e is the diffusion-abnormal user. Therefore, the business server 2000 may determine the user e as the diffusion-abnormal user. Subsequently, the business server 2000 may determine the abnormal users in the target user set 200a. The abnormal users may include the diffusion-abnormal user e, the abnormal user d, and the abnormal user k.

FIG. 2B is a diagram of a scenario for determining a diffusion-abnormal user according to an embodiment. As shown in FIG. 2B, by using the target user set 200a in the embodiments corresponding to FIG. 2A as an example, the business server 2000 may identify the user d and the user k as the abnormal users from the target user set 200a. For the implementation that the business server 2000 identifies the user d and the user k as the abnormal users from the target user set 200a, reference may be made to the description that the business server 2000 identifies the user d and the user k as the abnormal users from the target user set 200a in FIG. 2A. The business server 2000 may determine, according to the abnormal user d and the abnormal user k, that the target user set 200a is in the abnormal state. The diffusion-abnormal user may be determined according to the social relationship (that is, whether there are edges in the target user set 200a) between the abnormal user d and the abnormal user k. For example, if there is an edge between the abnormal user d and the user e, it may indicate that there is a social relationship between the user e and the abnormal user d. In this case, there is a certain probability that the user e is an accomplice of the abnormal user d, and then the business server 2000 may determine the user e as the diffusion-abnormal user. Similarly, if there is an edge between the abnormal user d and the user c, the business server 2000 may determine the user c as the diffusion-abnormal user. Similarly, if there is an edge between the abnormal user k and the user g, the business server 2000 may determine the user g as the diffusion-abnormal user. The business server 2000 may determine the abnormal users in the target user set 200a. The abnormal users include the diffusion-abnormal user e, the abnormal user d, the abnormal user k, the diffusion-abnormal user c, and the diffusion-abnormal user g.

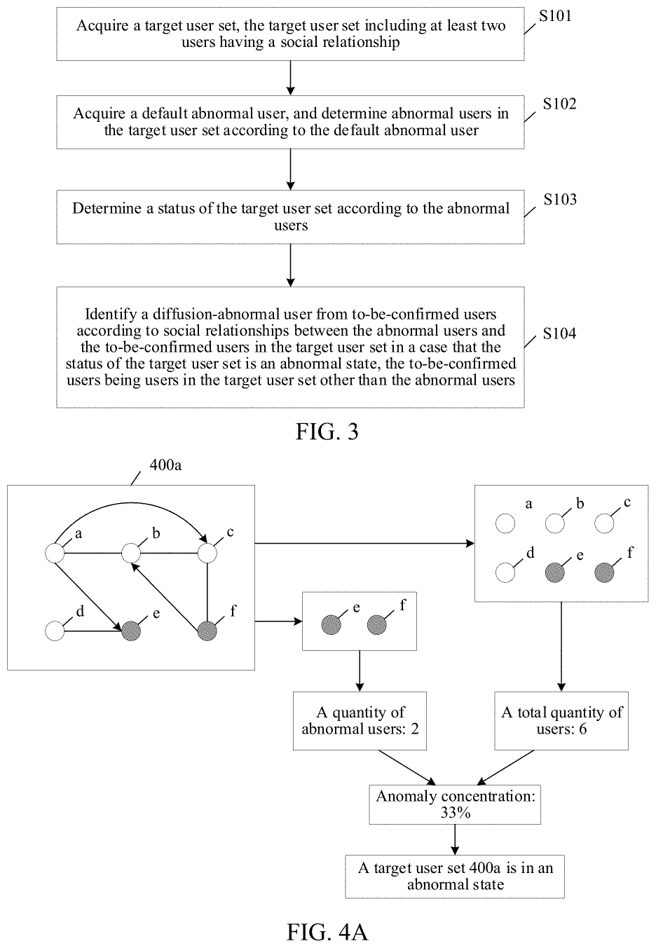

FIG. 3 is a schematic flowchart of a data identification method according to an embodiment. As shown in FIG. 3, a process of the method may include the following operations.

In operation S101, the system acquires a target user set, the target user set including at least two users having a social relationship.

In this operation, the target user set may be determined from a plurality of users. The plurality of users may be the plurality of users screened according to a preset condition, or the plurality of users corresponding to a back-end server, or all users (also referred to as a user group) of a social application. The determined target user set satisfies the condition of a closeness of social relationships among the users in the target user set being higher than a closeness of a social relationship between the users in the target user set and a user not in the target user set. The closeness of the social relationships among the users may be determined according to social behavior records of the users. For example, the social behavior records may include, but are not limited to, a frequency of information interaction among the users, information interaction times, information interaction durations, an information amount of interaction, a transaction amount, and the like.

In the embodiment of this disclosure, the target user set may be a community topology graph. The community topology graph includes nodes corresponding to the users, edges between the nodes, and an edge weight of each edge. The edge between the nodes is used for representing social relationships among the nodes (users). The edge weight is used for representing an association degree. If there is a social relationship between two users, there is an edge between the nodes corresponding to the two users. A closer relationship between the two users leads to a larger association degree and a larger edge weight. The community topology graph may be used for indicating whether there is a social relationship between the nodes, and indicating the association degree between the two nodes having the social relationship. The social relationship herein may be a payment relationship, a communication friend relationship, a device relationship, and the like. For example, in a case that the user a uses a communication device (such as a smart phone) of the user b to log in to an account, it may be determined that the user a has a device relationship with the user b. In addition to the payment relationship, the communication friend relationship, and the device association, the social relationship may further include relationships of other forms (for example, social accounts of the two users do not have a friend relationship, but the two users have had a conversation by using the social accounts). The range of the social relationship is not limited in this disclosure.

The target user set may be obtained from the relationship topology graph corresponding to the user group. Nodes in the target user set are some nodes in the relationship topology graph of the user group. According to the edge weights (that is, the association degrees among the users) among the nodes in the relationship topology graph, the relationship topology graph may be divided into at least two community topology graphs. Any of the at least two community topology graphs is selected as the target user set. The user group may be divided into at least two communities according to the social relationships and the association degrees among the users in the user group. The users in each community are closely related.

In operation S102, the system acquires a default abnormal user, and determining abnormal users in the target user set according to the default abnormal user.

In this embodiment, the default abnormal user may be a preset abnormal user sample. The abnormal user sample may be an abnormal user that is detected in advance. There may be at least two default abnormal users. The default abnormal users may include attribute information (such as IDs, names, fingerprints and the like) of the users. The attribute information is the ID by way of example. The ID of each user in the target user set may be matched with an ID of one of the default abnormal users. The users having a matching ratio reaching a matching threshold in the target user set may be determined as the abnormal users in the target user set.

The default abnormal users include <a default abnormal user 1, 1> and <a default abnormal user 2, 2>. The default abnormal users include the default abnormal user 1, and the ID of the default abnormal user 1 is 1. The default abnormal users further include the default abnormal user 2, and the ID of the default abnormal user 2 is 2. The target user set includes {<a user A, 1>, <a user B, 4>, and <a user C, 6>}. Then, the ID (that is, 1 and 2) of the default abnormal user 1 may be matched with the ID (that is, 1, 4, and 6) of the users in the target user set, so that matching result that the ID1 of the user A matches the ID1 of the default abnormal user 1 may be obtained. In this way, the user A may be determined as the abnormal user in the target user set.

In operation S103, the system determines a status of the target user set according to the abnormal user.

A status of the target user set may be determined according to a quantity of the abnormal users and a total quantity of the users in the target user set. An anomaly concentration of the target user set may be determined according to the quantity of the abnormal users and the total quantity of the users in the target user set. The anomaly concentration is a ratio of the quantity of the abnormal users in the target user set to the total quantity of the users. In a case that the anomaly concentration is less than a concentration threshold, it may indicate that the proportion of the abnormal users in the target user set is low, so that the status of the target user set may be determined as a normal state. In a case that the anomaly concentration is greater than the concentration threshold, it may indicate that the proportion of the abnormal users in the target user set is high, so that the status of the target user set may be determined as the abnormal state. A method for determining the anomaly concentration of the target user set may be shown in Equation (1):

C=N/M (1)

where C may be used for representing the anomaly concentration of the target user set, N may be used for representing the quantity of the abnormal users in the target user set, and M may be used for representing the total quantity of the users in the target user set.

In some embodiments, the status of the target user set may be determined by using a user social behavior feature set, for example, by acquiring the user social behavior feature set. The user social behavior feature set herein includes a social behavior feature of each user in the user group. The user social behavior feature set may include historical data of the social behavior feature of each user in the detected user group. For example, in a case that the user A has been to the Central Park and the Flower Town, two social behavior features of the user A having been to the Central Park and the Flower Town may be stored in the user social behavior feature set. It may be understood that, the user social behavior feature set may include communication devices used by the users, wireless networks, user behaviors (for example, frequently going to a same place), and the like. A type and a quantity of the social behavior features of the abnormal users in the target user set may be counted according to the user social behavior feature set. Information entropy may be determined according to the distribution of social behavior features of the abnormal users. A smaller information entropy may indicate a more concentrated distribution of the abnormal users on the social behavior features. For example, a method for determining the information entropy may be shown in Equation (2):

H(x)=−Σᵢ₌₁ⁿP(xᵢ)log P(xᵢ) (2)

where H(x) may be used for representing the information entropy, and P(xᵢ) may be used for representing the distribution of social behavior features of the users.

For example, the social behavior feature set includes three social behavior features: a wireless network, a user behavior, and a communication device, and i in Equation (2) may be 1, 2, and 3. In this way, the social behavior feature of the wireless network may be represented by x1, x2, and x3. The social behavior feature of the user behavior may be represented by x1, x2 and x3. The social behavior feature of the communication device may be represented by x1, x2, and x3. The wireless network being represented by x1, the user behavior being represented by x2, and the communication device being represented by x3 are used as an example. For the social behavior feature of the wireless network, a quantity of the abnormal users is 50. In the 50 abnormal users, 48 abnormal users use the same wireless network A, and 2 abnormal users use other different wireless networks B. Therefore, a quantity of the wireless networks as the social behavior feature is 3 (one wireless network A+one wireless network B+one wireless network C). Since 48 abnormal users in the 50 abnormal users use the same wireless network A, a small quantity of the wireless networks with small differences may indicate that the abnormal users are concentrated in distribution on the social behavior feature of the wireless network, so that a distribution P (the wireless network) of the abnormal users on the social behavior feature of the wireless network can be obtained (that is, a value of P(x₁) is P (the wireless network)). For the social behavior feature of the user behavior, 30 abnormal users go to the same coffee shop more than 10 times on a same day, and 20 abnormal users go to 20 different other places on a same day. Then, the quantity of the abnormal users distributed on the social behavior feature of user behavior is 21 (that is, one coffee shop+20 other places). Since 30 abnormal users in the 50 abnormal users go to the same coffee shop on the same day, it may indicate that the distribution of the abnormal users is relatively concentrated on the social behavior feature of the user behavior, so that the distribution P (the user behavior) of the abnormal users on the social behavior feature of the user behavior can be obtained (that is, a value of P(x₂) is P (the user behavior)). For the social behavior feature of the communication device, 10 abnormal users use a same communication device A to log in to the accounts, 5 abnormal users use a same communication device B to log in to the accounts, and 35 abnormal users use 35 different other communication devices to log in to the accounts. Then, the quantity of the abnormal users distributed on the social behavior feature of the communication device is 37 (that is, one communication device A+one communication device B+35 other communication devices). Since 35 abnormal users in the 50 abnormal users use different communication devices, a larger quantity of the communication devices with large differences may indicate that the distribution of the abnormal users on the social behavior feature of the communication device is disperse (that is, a concentration is low). In this way, the distribution P (the communication device) of the abnormal users on the social behavior feature of the communication device can be obtained (that is, a value of P(x₃) is P (the communication device)). According to the distribution P (the wireless network) of the abnormal users on the social behavior feature of the wireless network, the distribution P (the user behavior) of the abnormal users on the social behavior feature of the user behavior, the distribution P (the communication device) of the abnormal users on the social behavior feature of the communication device, and Equation (2), a first feature distribution H(x) of the abnormal users can be obtained. The first feature distribution H(x) herein is a total distribution value of the abnormal users on the three social behavior features of the wireless network, the user behavior, and the communication device.

Similarly, a second feature distribution of the users (including the abnormal users) in the target user set may be determined according to the social behavior features in the user social behavior feature set, that is, a feature distribution of the entire target user set. For the implementation of determining the second feature distribution, for example, reference may be made to the above description for determining the first feature distribution. According to the first feature distribution and the second feature distribution, a feature distribution difference (a difference between the first feature distribution and the second feature distribution) between the abnormal users and the users in the target user set may be determined. In a case that the feature distribution difference is less than a difference threshold, and the first feature distribution is less than a distribution threshold, it may indicate that the social behavior feature distribution of the abnormal users is concentrated, the distribution difference between the abnormal users and the entire target user set is small, which may indicate that the social behavior features of the abnormal users in the target user set are normal and popular. Therefore, the target user set is in the normal state. In a case that the feature distribution difference is greater than or equal to the difference threshold, and the first feature distribution is greater than or equal to the distribution threshold, it may indicate that the social behavior feature distribution of the abnormal users is disperse, and the distribution difference between the abnormal users and the entire target user set is large. In this way, it may indicate that the social behavior features among the abnormal users are inconsistent, and the social behavior features between the abnormal users and normal users are also inconsistent, which may indicate that the social behavior features of the abnormal users in the target user set are minority. Therefore, the target user set is in the normal state. If the feature distribution difference is greater than or equal to the difference threshold, and the first feature distribution is less than the distribution threshold, it may indicate that the social behavior feature distribution of the abnormal users is concentrated. In this way, the social behavior features among the abnormal users are relatively consistent, and a social behavior feature difference between the abnormal users and the normal users in the target user set is very large. Therefore, the target user set is in the abnormal state. For example, a method for determining the feature distribution difference may be shown in Equation (3):

$$\begin{matrix}{D}_{K L} ( P ‖ Q ) = {\sum }_{I} P ( i ) log \frac{P ( i )}{Q ( i )} & ( 3 )\end{matrix}$$

where D_{KL}(P∥Q) may be used for representing the feature distribution difference, P(i) may be used for representing the first feature distribution (that is, the distribution of the social behavior features of the abnormal users), and Q(i) may be used for representing the second feature distribution (that is, the distribution of the overall social behavior features of the users in the target user set).

In some embodiments, the status of the target user set may be determined by using the anomaly concentration of the target user set, or may be determined by using the user social behavior features, and may further be determined by combining the anomaly concentration and the user social behavior features. The anomaly concentration is first determined. After the anomaly concentration is greater than the concentration threshold, the user social behavior features are determined. The status of the target user set is determined as the abnormal state in a case that the conditions that the anomaly concentration is greater than the concentration threshold, the first feature distribution is less than the distribution threshold, and the feature distribution difference is greater than or equal to the difference threshold are simultaneously satisfied.

In operation S104, the system identifies a diffusion-abnormal user from to-be-confirmed users according to social relationships between the abnormal users and the to-be-confirmed users in the target user set in a case that the status of the target user set is an abnormal state, the to-be-confirmed users being users in the target user set other than the abnormal users.

In some embodiments, in a case that the status of the target user set is the abnormal state, users having social relationships with the abnormal users may be determined from the to-be-confirmed users and are determined as the diffusion-abnormal user. The having the social relationship herein may be, in the community topology graph in which the node corresponding to the abnormal user is located, edges starting from the abnormal users that exist between the nodes corresponding to the abnormal users and the nodes corresponding to the to-be-confirmed users.

Referring to FIG. 2B as an example, the abnormal users include the user d and the user k. The node d can reach the node e and the node c. The node k can reach the node g. Therefore, the user e corresponding to the node e, the user c corresponding to the node c, and the user g corresponding to the node g may be all determined as the diffusion-abnormal users.

In some embodiments, in a case that the status of the target user set is the abnormal state, the user having the social relationship with the abnormal user is determined from the to-be-confirmed users. Abnormal user nodes corresponding to the abnormal users are acquired. Association user nodes corresponding to the users having the social relationship with the abnormal users are acquired. The association user nodes having an edge weight with one of the abnormal user nodes greater than an association threshold are determined as a diffusion-abnormal node. In this way, the user corresponding to the diffusion-abnormal node is determined as the diffusion-abnormal user.

Referring to FIG. 2A as an example, the abnormal users include the user d and the user k. The node d can reach the node e and the node c. Then, the node e and the node c may be determined as the association user nodes of the node d. An edge weight from the node d to the association user node e is 0.8, which is greater than the association threshold of 0.75. An edge weight from the node d to the association user node c is 0.56, which is far less than the association threshold of 0.75. Therefore, the association user node e may be determined as the diffusion-abnormal node. The node k can reach the node g, so that the node g may be determined as the association user node of the node k. An edge weight from the node k to the association user node g is 0.5, and 0.5 is far less than the association threshold of 0.75. Therefore, the association user node g is not the diffusion-abnormal node.

It can be learned from the above that, in the dividing the users having the social relationships into the target user set, in a case that the abnormal users in the target user set are determined and the target user set is in the abnormal state, the users having the social relationship with the abnormal user may be acquired from the target user set and are directly used as the diffusion-abnormal user without performing feature matching on each user. The identification of the diffusion-abnormal user can be performed by using the social relationship. Therefore, even if the diffusion-abnormal users have the same feature as the normal users, the diffusion-abnormal user may still be identified due to the social relationship with the abnormal user. In this way, the accuracy of identification can be enhanced.

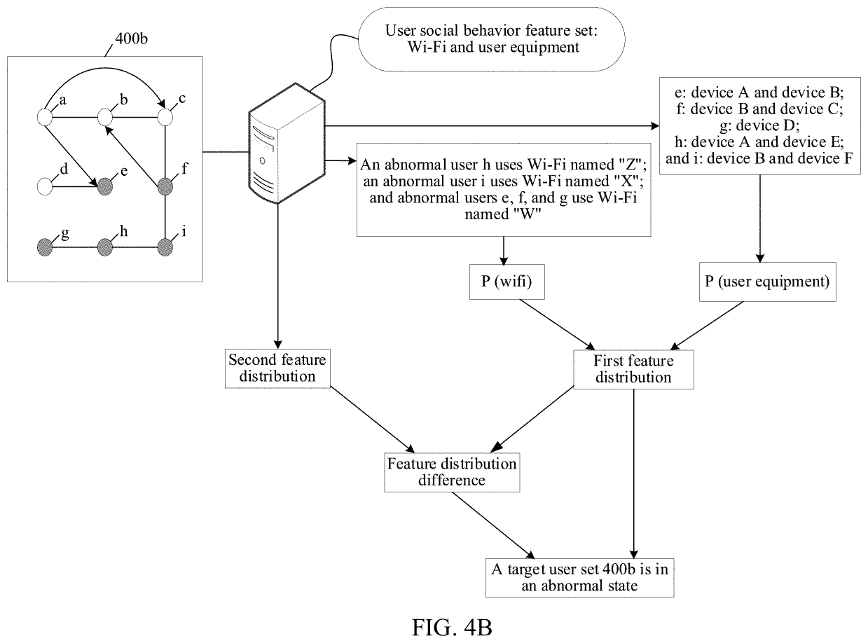

FIG. 4A is a diagram of a scenario for determining a status of a target user set according to an embodiment. As shown in FIG. 4A, the target user set 400a is used as an example. The abnormal users in the target user set 400a include the user e and the user f. According to the abnormal user e and the abnormal user f, a business server may count a quantity of the abnormal users as 2. According to the user a, the user b, the user c, the user d, the user e, and the user fin the target user set 400a, the business server may count a total quantity of the users in the target user set 400a as 6. In this way, the anomaly concentration of the target user set 400a is 2/6=33%. Because the anomaly concentration of 33% is greater than the concentration threshold of 20%, the business server may determine the status of the target user set 400a as the abnormal state.

FIG. 4B is a diagram of a scenario for determining a status of a target user set according to an embodiment. As shown in FIG. 4B, the target user set 400b is used as an example. The abnormal users in the target user set 400b include the user e, the user f, the user g, the user h, and the user i. The user social behavior feature set includes Wi-Fi and user equipment. It can be determined, according to the user social behavior feature set, that a Wi-Fi name used by the abnormal user h is “Z”, a Wi-Fi name used by the abnormal user i is “X”, and a Wi-Fi name used by the abnormal user e, the abnormal user f, and the abnormal user g is “W”. Then it may be seen that, for the social behavior feature of Wi-Fi, 60% of the abnormal users use the same Wi-Fi, and therefore the distribution of the abnormal users on the social behavior feature of Wi-Fi is concentrated. According to this distribution, a distribution P (Wi-Fi) of the abnormal users on the social behavior feature of Wi-Fi may be obtained. Similarly, it can be determined, according to the user social behavior feature set, that devices used by the abnormal user e are a device A and a device B, devices used by the abnormal user f are the device B and a device C, a device used by the abnormal user g is a device D, devices used by the abnormal user h are the device A and a device E, and devices used by the abnormal user are the device B and a device F. Therefore, it may be seen that 3 abnormal users use the same device, that is, the device B, and 2 abnormal users use the same device A. In this way, the distribution of the abnormal users on the social behavior feature of user equipment is relatively concentrated. According to this distribution, a distribution P (user equipment) of the abnormal users on the social behavior feature of user equipment may be obtained. According to the distribution P (Wi-Fi) of the abnormal users on the social behavior feature of Wi-Fi, the distribution P (user equipment) of the abnormal users on the social behavior feature of user equipment, and Equation (2), a first feature distribution A of the abnormal users on the social behavior features may be obtained. Similarly, a second feature distribution B of the overall social behavior features of the users (including the abnormal user e, the abnormal user f, the abnormal user g, the abnormal user h, and the abnormal user i) in the target user set may be obtained. According to the first feature distribution A, the second feature distribution B, and Equation (3), a difference between the social behavior feature distribution of the abnormal users and the overall social behavior feature distribution of the target user set 400b may be obtained, that is, a feature distribution difference of the abnormal users is C. Since the first feature distribution A is less than a distribution threshold D, and the feature distribution difference C is greater than a difference threshold E, the business server may determine the status of the target user set 400b as the abnormal state.

In the various embodiments, in a case that the target user set is determined from the plurality of users, the plurality of users may be divided into at least two user sets according to collected social relationships and social behaviors among the plurality of users, so that a closeness of a social relationship among users in each user set is higher than a closeness of a social relationship among users in a different user set. Each of the plurality of user sets is used as the target user set.

In some embodiments, in a case that the plurality of users are divided into the plurality of user sets, a relationship topology graph may be determined according to the social relationships and social behaviors among the plurality of users. In the relationship topology graph, each node corresponds to one of the plurality of users. An edge connecting two nodes indicates that there is a social relationship between the users corresponding to the two nodes. A closeness of the social relationship between the two users is determined according to the social relationships and the social behaviors among the plurality of users. A weight of the edge between the nodes corresponding to the two users is determined according to the closeness. The relationship topology graph is divided into at least two topology sub-graphs by using a clustering algorithm. A set of the users corresponding to the nodes in one of the at least two topology sub-graphs is used as the target user set.

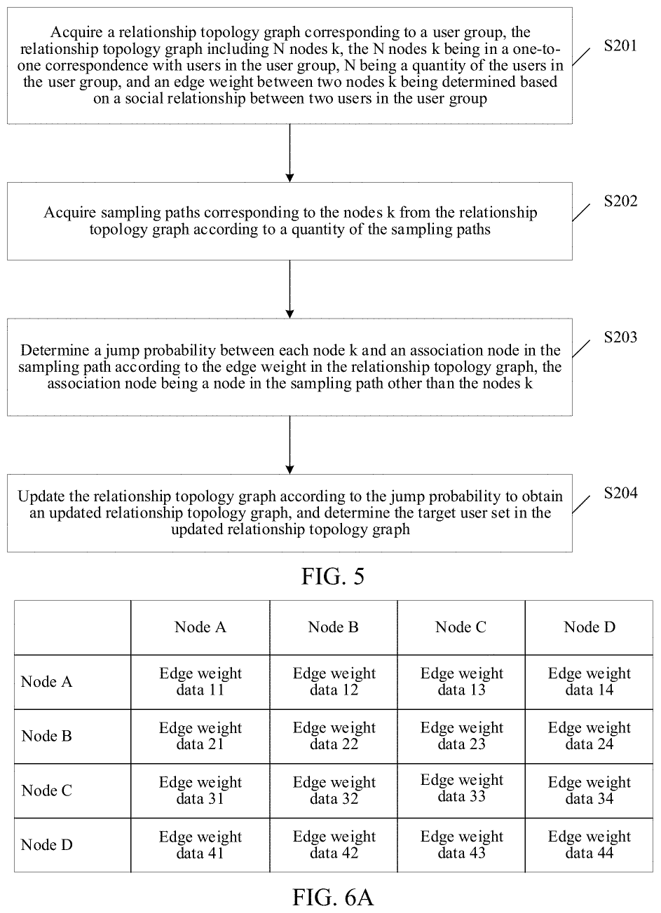

FIG. 5 is a diagram of a process for acquiring a target user set according to an embodiment. As shown in FIG. 5, the process may include the following operations:

In operation S201, the system acquires a relationship topology graph corresponding to a user group. The relationship topology graph includes N nodes k. The N nodes k are in a one-to-one correspondence with the users in the user group. N is a quantity of the users in the user group, and k refers to a general index that is specified per node (e.g., a user A may correspond to a node A, where ‘A’ in this instance is the specific index to which ‘k’ generally referred). An edge weight between two nodes k is determined based on a social relationship between two users in the user group.

In some embodiments, N may be the quantity of the users in the user group. Each user in the user group may serve as the node k after the user group is acquired. For example, the user A serve as the node A, and the user B serve as the node B. According to the social relationship between the two users in the user group, the edge weight between the two nodes k in the relationship topology graph may be determined. One user group has N users, and each user may correspond to one node k. In a case that there is a social relationship between the two users, an edge connection between the two nodes k corresponding to the two users may be performed. According to social behavior records between the users having the social relationship, an initial weight may be set for the edge between the nodes k. Probability transformation is performed on the initial weight. A result after the probability transformation is used as the weight of the edge between the nodes k. In this way, the relationship topology graph corresponding to the user group may be generated according to the node k corresponding to the user group and the edge weight. The social behavior records herein may be a transfer amount, a transfer frequency, a communication frequency, and a communication duration between the users having the social relationship. A larger transfer amount, a higher transfer frequency, a higher communication frequency, or a longer communication duration between the two users leads to a larger initial weight set for the edge between the two users. The probability transformation herein may be standardization on the initial weight of each edge. For example, for the node i and the node j, an edge exists between the node i and the node j, and the edge between the node i and the node j may be expressed as Mij. Then the probability transformation of Mij may be shown in Equation (4):

$${M}_{i j} = \frac{{w}_{ij}}{{Σ}_{i = 1}^{n} {w}_{ij}} \qquad ( 4 )$$

where, Wᵢⱼ represents the initial weight between the node i and the node j, and Σᵢ₌₁ⁿWᵢⱼ represents a sum of the initial weights between the n nodes and the node j.

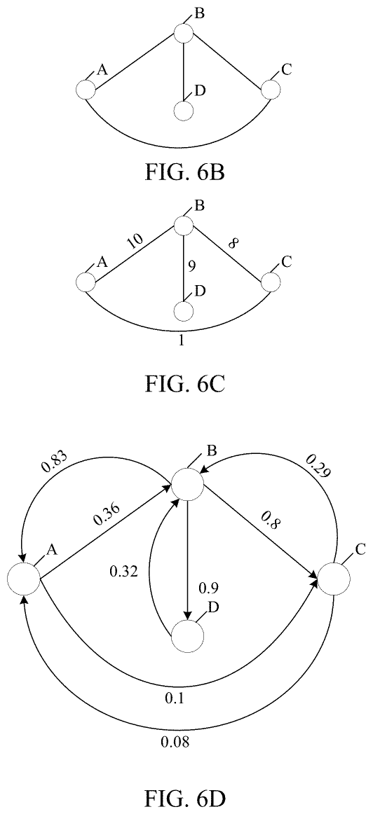

FIG. 6A is a diagram of a node relationship list according to an embodiment. The user group includes the user A, the user B, the user C, and the user D by way of example. The user A serves as the node A, the user B serves as the node B, the user C serves as the node C, and the user D serves as the node D. In order to visually show the social relationships among the users, the relationships among the node A, the node B, the node C, and the node D are expressed in the form of a list (FIG. 6A). A list shown in FIG. 6A may be used for expressing a node relationship list corresponding to the users. The node relationship list may include a first header parameter, a second header parameter, and data jointly corresponding to the first header parameter and the second header parameter. The data jointly corresponding to the first header parameter and the second header parameter may include edge weight data. One piece of edge weight data corresponds to two nodes. The edge weight data may be used for indicating the degree of association between the two nodes. A larger edge weight leads to a larger degree of association between the two nodes. The first header parameter may be a row parameter, and the second header parameter may be a column parameter. Alternatively, the first header parameter may be the column parameter, and the second header parameter may be the row parameter.

According to the node relationship list shown in FIG. 6A, an adjacency matrix A1 for representing the relationships among the node A, the node B, the node C, and the node D may be obtained. The adjacency matrix A1 is shown in the following matrix:

$$[ \begin{matrix}1 & 1 & 1 & 0 \\ 1 & 1 & 1 & 1 \\ 1 & 1 & 1 & 0 \\ 0 & 1 & 0 & 1\end{matrix} ] \qquad Adjacency matrix A 1$$

The adjacency matrix A1 is the matrix of 4×4. A value 1 in the adjacency matrix A1 may be used for indicating that there is a social relationship (that is, an edge is connected between the nodes) between the two users, and a value 0 may be used for indicating that there is no social relationship (that is, no edge is connected between the nodes) between the two users. For example, there is a social relationship between the user A and the user B, and an edge connection between the user A and the user B is required, so that the edge weight data M₁₂ jointly corresponding to the node A and the node B is set to 1. There is no social relationship between the user D and the user A, and therefore it is not necessary to perform edge connection on the node D and the node A. Then the edge weight data M₄₁ jointly corresponding to the node D and the node A is set to 0. Herein, a loop is added to each node. An edge is added to each node. The edge weight data M₁₁, the edge weight data M₂₂, the edge weight data M₃₃, and the edge weight data M₄₄ are all set to 1.

FIG. 6B is a diagram of a node relationship according to an embodiment. According to the adjacency matrix A1, a node relationship graph corresponding to the user A, the user B, the user C, and the user D may be obtained, as shown in FIG. 6B (FIG. 6B is obtained by performing edge connection between the nodes corresponding to the value 1 in the adjacency matrix A1). Here, the addition of a loop edge for each node means that, in a subsequent computing process, the edge weight (the edge weight is 1) corresponding to the loop edge needs to be used, that is, it is only necessary to obtain the edge weight of each loop edge. Therefore, the loop edge of each node will not be shown in FIG. 6B.

Further, according to the social behavior records among the user A, the user B, the user C, and the user D, the initial weight can be set for each edge. For the user A and the user B, the user A transferred money to the user B twice, and the transfer amount in total reaches 100 thousand, so that the initial weight of the edge between the node A and the node B may be set to 10. For the user A and the user C, there is no social behavior records (that is, there is no transfer behavior or call behavior between the user A and the user C) between the user A and the user C, so that the initial weight of the edge between the node A and the node B may be set to 1. For the user B and the user C, the user B frequently communicates with the user C, and each call lasts more than 20 minutes, so that the initial weight of the edge between the node B and the node C may be set to 8. For the user B and the user D, the user B frequently transfers money to the user D, so that the initial weight of the edge between the node B and the node D may be set to 9.

FIG. 6C is a diagram of a node relationship including an initial weight according to an embodiment. According to the social behavior records, a node relationship graph FIG. 6C including the initial weights may be obtained. According to the initial weights and the adjacency matrix A1, an adjacency matrix A2 for representing the relationships among the node A, the node B, the node C, and the node D and the degree of association may be obtained. The adjacency matrix A2 is shown in the following matrix:

$$[ \begin{matrix}1 & 10 & 1 & 0 \\ 10 & 1 & 8 & 9 \\ 1 & 8 & 1 & 0 \\ 0 & 9 & 0 & 1\end{matrix} ] \qquad Adjacency matrix A 2$$

The adjacency matrix A2 is the matrix of 4×4.

Probability transformation (that is, standardization) may be performed on elements (that is, the initial weights) in the adjacency matrix A2. For example, a method for probability transformation may be as follows. By using an element M₁₂ (that is, the initial weight of the edge between the node A and the node B) as an example, the initial weight of the edge from the node A to the node B (that is, the element M₁₂) may be 10, then the initial weight of the edge from the node A to the node C is 1, the initial weight of the edge from the node C to the node B is 8, and the initial weight of the edge from the node D to the node B is 9. The element M₁₂, an element M₂₂, an element M₃₂, and an element M₄₂ in the column where the element M₁₂ is located in the adjacency matrix A2 are acquired. By adding up values of the element M₁₂, the element M₂₂, the element M₃₂, and the element M₄₂, an addition result of 28 may be obtained. According to the value 10 of the element M₁₂ and the addition result of 28, a result of 10/28=0.36 after the probability transformation on the element M₁₂ may be obtained, and then 0.36 may be used as the edge weight from the node A to the node B. Similarly, the edge weights of other edges may be obtained. According to the adjacency matrix A2 and the edge weights after the probability transformation is performed on each element, a probability matrix A3 for representing the relationships among the node A, the node B, the node C, and the node D and the degree of association may be obtained. The probability matrix A3 is shown in the following matrix:

$$[ \begin{matrix}1 & 0.36 & 0.1 & 0 \\ 0.83 & 1 & 0.8 & 0.9 \\ 0.08 & 0.29 & 1 & 0 \\ 0 & 0.32 & 0 & 1\end{matrix} ] \qquad Probability matrix A3$$

The probability matrix A3 is the matrix of 4×4.

The probability transformation is not required to be performed on the edge weights (that is, the element M¹¹, the element M₂₂, the element M₃₃, and the element M₄₄) between each node and the respective nodes.

FIG. 6D is a diagram of a relationship topology graph according to an embodiment. According to the node A, the node B, the node C, the node D, and the edge weight between the nodes, a relationship topology graph corresponding to the user group (including the user A, the user B, the user C, and the user D) may be obtained, as shown in FIG. 6D.

In operation S202, the system acquires sampling paths corresponding to the nodes k from the relationship topology graph according to a quantity of sampling paths.

In some embodiments, for each node in the relationship topology graph, a jump probability that each node reaches other nodes in the relationship topology graph may be calculated by walking, so as to obtain a community of each node. For example, the calculation method may be shown in Equation (5):

Expa(Mᵢⱼ)=Σ_{k=1:n}Mᵢₖ*Mₖⱼ (5)

where (Mᵢⱼ) may be used for representing the jump probability from the node i to the node j, Mᵢₖ may be used for representing the probability (the edge weight) from the node i to the node k, and Mₖⱼ may be used for representing the probability (the edge weight) from the node k to the node j.

For example, there is no edge connection between the node A and the node D, but there is an edge connection between the node A and the node B, an edge connection between the node B and the node C, and an edge connection between the node C and the node D, which may indicate that the node A may walk 3 steps to reach the node D (that is, the node A-the node B-the node C-the node D). The edge weight from the node A to the node B is 0.2, the edge weight from the node B to the node C is 0.3, and the edge weight from the node C to the node D is 0.4. Then, the jump probability of 0.2×0.3×0.4=0.024 from the node A to the node D may be obtained according to Equation (5).

Since there is a large quantity of the users in the user group, that is, there is a large quantity of nodes, in a case that the jump probability from each node to other nodes in the relationship topology graph is calculated, the scale is huge, which may cause a waste of time and space. In order to save time and space, in this solution, a Monte-Carlo (MCL) sampling walking method is used for calculation, that is, a path of each node is sampled, thereby calculating the jump probability from each node to other nodes in the sampling path of the node. In this solution, the probability from each node to all of other nodes does not need to be calculated. It is only necessary to sample the path of each node according to the quantity of the sampling paths, to acquire the sampling path of each node. An association node in the sampling path may be acquired according to a jump threshold. Then, the jump probability from each node to the association node in the sampling path is calculated. Since only the jump probability from each node to some nodes in the relationship topology graph is calculated, the jump probability from each node to all of the nodes in the relationship topology graph does not need to be calculated. In this way, a large amount of calculation can be reduced, and time consumption and space consumption can be reduced. The quantity of the sampling paths and the jump time of each node may be controlled manually, and a result obtained after the sampling may also be controlled within an error range. In addition, due to the sampling of data, in a case that the user group, that is, a data scale, is huge, the MCL sampling walking method may also rapidly complete the calculation and obtain high-accuracy results.

In some embodiments, the quantity of the sampling paths is a non-zero positive integer. The quantity of the sampling paths may be a value specified by people, or may be a value randomly generated by a server within an allowable range of values. According to the quantity of the sampling paths, the sampling path corresponding to each node k may be acquired from the relationship topology graph corresponding to the user group. The sampling path refers to extraction of some paths corresponding to the quantity of the sampling paths from the paths using the node k as an initial node. According to the jump threshold, the association node of each node k may be determined from the sampling path of each node k. The association node is the node in the sampling path other than the node k. For example, the association node may be the node that is reachable by jumping within the jump threshold (including the jump threshold) by starting from the node k. For example, the relationship topology graph in the embodiment corresponding to FIG. 6D is used as an example. In the relationship topology graph of FIG. 6D, the paths using the node A as the initial node include a path A-B-C, a path A-B-C, and a path A-C-B. The quantity of the sampling paths is 1. It may be necessary to extract one path from the paths of the node A as the sampling path of the node A. For example, the path A-B-C is the sampling path of the node A. The jump threshold is 1. The path A-B-C starts from the node A, the node A can reach the node B by jumping 1 step, and in the path A-B-C, the node B may be used as the association node of the node A. The association threshold is a maximum limit of a quantity of jump steps in the sampling path. For each node k in the relationship topology graph, the node k is used as the initial node, and jumping is started when the quantity of jump steps is 1. The quantity of steps for each jumping is incremented. For example, a sampling path of the node c is c-e-g-k-i-j, and the jump threshold is 4. Starting from the node c, the node c can reach the node e by jumping 1 step. After 1 is added to the quantity of jump steps, the quantity of jump steps is increased from 1 to 2, and the node g can be reached by jumping 2 steps (reaching the node g via the node e). The node k can be reached by jumping 3 steps (passing the node e and the node g) in a case that the jump step is increased from 2 to 3. The node i can be reached by jumping 4 steps (passing the node e, the node g, and the node k) in a case that the jump step is increased from 3 to 4. Therefore, in the sampling path c-e-g-k-i-j of the node c, the node e, the node g, the node k, and the node i may be determined as the association nodes of the node c.

In operation S203, the system determines a jump probability between the node k and an association node in the sampling path according to the edge weight in the relationship topology graph, the association node being a node in the sampling path other than the node k.

In some embodiments, the jump probability of the node k and the association node may be determined according to the edge weight in the relationship topology graph corresponding to the user group. For example, in a case that there is no edge between the node k and the association node, in the sampling path of the node k, an intermediate node between the node k and the association node of the node k may be acquired. The node k may reach the association node through the intermediate node. In the node k, the intermediate node, and the association node having the edge, the two nodes may be used as a connection node pair. According to the edge weight corresponding to the connection node pair, the jump probability between the node k and the association node may be determined.

Referring to FIG. 6D as an example, in a case that a sampling path of the node A is A-B-D, the jump threshold is 3, and the quantity of jump steps may be 1 and 2, the association node of the node A is the node B and the node D. There is no edge between the node A and the node D, but the node A may reach the node D through the node B, and the node B may be used as the intermediate node between the node A and the node D. In a case that there is an edge between the node A and the node B, and there is an edge between the node B and the node C, the node A and the node B may be used as a connection node pair AB, and the node B and the node C may be used as a connection node pair BC. In this way, according to the probability matrix A3, the edge weight between the connection node pair AB is 0.36, and the edge weight between the connection node pair BC is 0.8, so that the jump probability between the node A and the node C may be 0.36×0.8=0.288.

In operation S204, the system updates the relationship topology graph according to the jump probability to obtain an updated relationship topology graph, and determine the target user set from the updated relationship topology graph.

In some embodiments, the relationship topology graph may be updated according to the jump probability. Edges connected in the relationship topology graph may be updated according to the node k and the association node. An edge connection (adding new edges to the relationship topology graph) is performed on each node k and the association nodes having no edges with the node, so as to obtain a transition relationship topology graph. For example, by using an embodiment corresponding to FIG. 6D as an example, the association node of the node A is the node B and the node D. The node A may reach the node D through the node B, the edge connection between the node A and the node D may be performed, and a direction is set for the edge to indicate that the edge is from the node A to the node D. In the transition relationship topology graph, the jump probability between the node k and the association node may be set as the edge weight between the node k and the association node to obtain a target relationship topology graph. The target relationship topology graph is the updated relationship topology graph.

By using the embodiment corresponding to FIG. 6D as an example, the sampling path of the node A is A-B-D, and the jump probability from the node A to the node D may be 0.36×0.9=0.324 according to the probability matrix A3. The sampling path of the node B is B-A-C, and the jump probability from the node B to the node C may be 0.83×0.1=0.083. The sampling path of the node C is C-A-B-D, and the jump probability from the node C to the node B may be 0.08×0.36=0.029. The sampling path of the node D is D-B-A, and the jump probability from the node D to the node A may be 0.32×0.83=0.266. The jump probability is used as the edge weight, and the probability matrix A3 may be updated, so as to obtain a probability matrix A4 for representing the relationships among the node A, the node B, the node C, and the node D and the degree of association. The probability matrix A4 is shown in the following matrix:

$$[ \begin{matrix}0 & 0.36 & 0 & 0.324 \\ 0.83 & 0 & 0.083 & 0 \\ 0.08 & 0.029 & 0 & 0.026 \\ 0.266 & 0.32 & 0 & 0\end{matrix} ] \qquad Probability matrix A4$$

The probability matrix A4 is the matrix of 4×4. An element 0 in the probability matrix A4 indicates that the nodes are unreachable. For example, an element M₁₃ (that is, the edge weight from the node A to the node C) is used as an example. Although in the probability matrix A3, the probability from the node A to the node C is 0.1 (the node A can reach the node C, and there is an edge between the node A and the node C), the extracted path of the node A is A-B-D, other unextracted paths of the node A are not taken into account. It is only necessary to consider the paths from the node A to the node B and from the node A to the node D (that is, an element M₁₂ and an element M₁₄ in the probability matrix A4).

Further, in the target relationship topology graph, convex transformation may be performed on the edge weight (the jump probability) in the target relationship topology graph. That is to say, exponential growth is performed on the edge weight, and probability transformation (that is, standardization) is performed on the jump probability obtained after the exponential growth. After the convex transformation, a target probability may be obtained. The edge weight between the node k and the association node of the node k may be updated according to the target probability. In these updated edge weights, in a case that there is the association node greater than the weight threshold, the association node having an updated edge weight greater than or equal to the weight threshold may be determined as a vital association node of the node k. The target relationship topology graph may be divided into at least two community topology graphs according to the node k and the vital association node of the node k. A target community topology graph is acquired from the at least two community topology graphs as the target user set.

The exponential growth is performed on the jump probability. The probability transformation (standardization) is performed on the jump probability obtained after the exponential growth. That is, convex transformation is performed on the jump probability. The method for obtaining the target probability, for example, may be shown in Equation (6):

$${Γ}_{r} ( {M}_{i j} ) = \frac{{( {M}_{ij} )}^{r}}{{{Σ}_{i = 1}^{n} ( {M}_{ij} )}^{r}} \qquad ( 6 )$$

where Γᵣ(Mᵢⱼ) is used for representing the target probability from the node i to the node j, Mij is used for representing the edge weight from the node i to the node j, (M^{ij})^{r} is used for representing that the exponential growth is performed on the edge weight from the node i to the node j for r times, and Σᵢ₌₁ⁿ(Mᵢⱼ)^{r} represents a sum of weights of the edge weight from n nodes to the node j after the exponential growth for r times.

The probability matrix A4 and r being 3 are used as an example. For the target probability (that is, Γᵣ (M₂₁) from the node B to the node A, the exponential growth may be first performed on M₂₁ for 3 times, that is, 0.83×0.83×0.83=0.572. The sum after the exponential growth is performed on the element M₁₁, the element M₂₁, the element M₃₁, and the element M₄₁ respectively for 3 times is 0³+0.83³+0.08³+0.266=0.591, and then Γᵣ(M₂₁) may be 0.572/0.591=0.968. For the target probability (that is, Γᵣ(M₄₁)) from the node D to the node A, the exponential growth may be first performed on M₄₁ for 3 times, that is, 0.266×0.266×0.266=0.019. The sum after the exponential growth is performed on the element M₁₁, the element M₂₁, the element M₃₁, and the element M₄₁ respectively for 3 times is 0³+0.83³+0.08³+0.266=0.591, and then Γᵣ(M₄₁) may be 0.019/0.591=0.032. In a case that the element M₂₁ is 0.83, a value after the exponential growth and standardization is 0.968. In a case that the element M₄₁ is 0.266, a value after the exponential growth and standardization is 0.032. Therefore, it can be determined that, by means of the exponential growth and standardization of the elements, the value having a large element (the edge weight) may become larger (for example, 0.83 is changed to 0.968), and the value having a small element (the edge weight) may become smaller (for example, 0.266 is changed to 0.032). That is to say, in this solution, by means of the MCL sampling walking method and the convex transformation, the degree of association between the users may become closer, or the degree of association between the users may become weaker, which facilitates the division of communities, so that the dividing result is more accurate.

In some embodiments, before the community topology graph is divided, a quantity of iterations may be set, so that steps from acquisition of the sampling paths to calculation of the target probability may be repeated for a plurality of times. That is to say, random sampling is performed on each node k for the first time, and then the target probability is used as the edge weight between the nodes after the target probability between the nodes is calculated. Then, random sampling is performed for the second time, and the target probability between the nodes is calculated. In the second sampling path, the target probability is used as the edge weight to calculate a new target probability between the nodes. In this way, the steps are repeated until the quantity of iterations are reached, so that the final target probability may be determined as a stable probability, and then the community topology graph is divided by using the stable target probability.

It can be learned from the above that, in the dividing the users having the social relationships into the target user set, in a case that the abnormal users in the target user set are determined and the target user set is in the abnormal state, the users having the social relationship with the abnormal user may be acquired from the target user set and are directly used as the diffusion-abnormal user without performing feature matching on each user. The identification of the diffusion-abnormal user can be performed by using the social relationship. Therefore, even if the diffusion-abnormal user has the same features as the normal user, the diffusion-abnormal user can still be identified because the diffusion-abnormal user has the social relationship with the abnormal user, thereby improving the accuracy of identification.

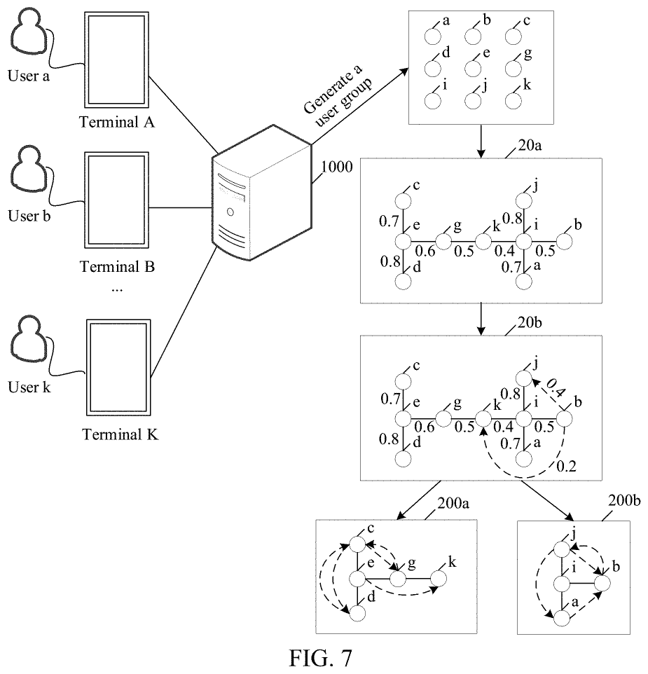

FIG. 7 is a diagram of a scenario for dividing a community topology graph according to an embodiment. As shown in FIG. 7, a business server 1000 may determine a user a corresponding to a terminal A, a user b corresponding to a terminal B, . . . , a user k corresponding to a terminal K as a user group {a, b, c, e, f, g, i, j, and k}. The business server 1000 may use each user in the user group as a node. The business server 1000 may perform edge connection between the nodes according to a social relationship between the users, to generate a relationship topology graph corresponding to the user group {a, b, c, e, f, g, i, j, and k}. Then, edge weights may be determined for edges in the relationship topology graph according to social behavior records between the users. As shown in FIG. 7, an edge weight between the node c and the node e is 0.7, an edge weight between the node e and the node d is 0.8, an edge weight between the node e and the node g is 0.6, an edge weight between the node g and the node k is 0.5, an edge weight between the node k and the node i is 0.4, an edge weight between the node i and the node j is 0.8, an edge weight between the node i and the node a is 0.7, and an edge weight between the node i and the node b is 0.5. According to a quantity of 2 of the sampling paths, the business server 1000 may perform path sampling on the nodes in the relationship topology graph 20a (before sampling) to obtain the sampling path corresponding to each node. By using the node b as an example, the way for acquiring the sampling paths of other nodes is consistent with that of the node b, and the details are not described herein again. Paths using the node b as an initial node include 4 paths: b-i-j, b-i-a, b-i-k-g-e-c, and b-i-k-g-e-d. The business server 1000 may extract two paths of b-i-j and b-i-k-g-e-c from the 4 paths of b-i-j, b-i-a, b-i-k-g-e-c, and b-i-k-g-e-d, and use b-i-j and b-i-k-g-e-c as sampling paths of the node b. Then, the business server 1000 may acquire a jump threshold of 2. According to the jump threshold of 2, as shown in FIG. 7, in the sampling path of b-i-j, the node j can be reached by jumping at the node b twice (jumping from the node b to the node i connected to the node b, and then jumping from the node i to the node j connected to the node i). Although there is no edge between the node b and the node j, there is an indirect connection relationship. The business server 1000 may perform the edge connection between the node b and the node j, and add a direction to the edge for indicating that the edge is from the node b to the node j. According to the edge weight of 0.5 between the node b and the node i and the edge weight of 0.8 between the node i and the node j, the business server 1000 may obtain the edge weight of 0.4 between the node b and the node j. In the sampling path of b-i-k-g-e-c, starting from the node b, the node that can be reached by jumping twice is the node k. Then, in the sampling path of b-i-k-g-e-c, although the node g, the node e, and the node c are all in the sampling path, the business server 1000 only needs to calculate the jump probability from the node b to the node k without calculating the jump probability among the node g, the node e, and the node c. According to the edge weight of 0.5 between the node b and the node i and the edge weight of 0.4 between the node i and the node k, the business server 1000 may obtain the jump probability of 0.2 from the node b to the node k. The business server 1000 may perform the edge connection between the node b and the node k, and add a direction to the edge for indicating that the edge is from the node b to the node j. By using 0.2 as the edge weight between the node b and the node k, the business server 1000 may use the nodes (that is, the node i, the node j, and the node k) in the sampling path other than the node b as the association nodes of the node b. In this way, after the path sampling is performed on the node b, the edge weights between the node b and the association nodes (that is, the node i, the node j, and the node k) of the node b may be respectively 0.5 (from the node b to the node i), 0.4 (from the node b to the node j), and 0.2 (from the node b to the node k). Similarly, the business server 1000 may obtain the sampling paths of other nodes and the jump probability that other nodes reach the association nodes. The sampling path of each node and the jump probability from the node to the association node of the node may be shown in Table 1:

TABLE 1

| | a | b | C | d | e | g | i | j | k |
|---|---|---|---|---|---|---|---|---|---|
| a | | 0.35 | | | | | 0.7 | | 0.28 |
| b | | | | | | | 0.5 | 0.4 | 0.2 |
| c | | | | 0.56 | 0.7 | 0.42 | | | |
| d | | | 0.56 | | 0.8 | 0.48 | | | |
| e | | | | 0.8 | | 0.6 | | | 0.3 |
| g | | | 0.42 | | 0.6 | | 0.2 | | 0.5 |
| i | 0.7 | | | | | 0.2 | | | 0.4 |
| j | 0.7 | 0.4 | | | | | 0.8 | | |
| k | | 0.2 | | | | | 0.4 | 0.32 | |

In Table 1, the column data represents the initial nodes, and the row data represents arrival nodes. The node a is used as an example. The jump probability from the node a to the node b is 0.35, the jump probability from the node a to the node i is 0.7, and the jump probability from the node a to the node k is 0.28. It can be determined from Table 1 that, the edge weights greater than or equal to the weight threshold of 0.5 include as follows. The jump probability from the node a to the node i is 0.7, the jump probability from the node b to the node i is 0.5, the jump probability from the node c to the node d is 0.56, the jump probability from the node c to the node e is 0.7, the jump probability from the node d to the node c is 0.56, the jump probability from the node d to the node e is 0.8, the jump probability from the node e to the node d is 0.8, the jump probability from the node e to the node g is 0.6, the jump probability from the node g to the node k is 0.5, the jump probability from the node i to the node a is 0.7, the jump probability from the node j to the node a is 0.7, and the jump probability from the node j to the node i is 0.8. Then, the business server 1000 may use the jump probability as the edge weight of each edge to obtain a target relationship topology graph 20b (after sampling). The node having the edge weight greater than the weight threshold may be divided into one community. The business server 1000 may divide the node c, the node e, the node d, the node g, and the node k into one community, and divide the node i, the node j, the node a, and the node b into one community. Therefore, a community topology graph 200a (that is, the community) and a community topology graph 200b (that is, the community) may be obtained from the target relationship topology graph 20b (after sampling). As shown in FIG. 7, it can be determined that, the edge weights among the nodes in the community 200a and the community 200b are all less than the weight threshold, or there is no edge between the two nodes (that is, the degree of association among the users in the two communities is low). For example, the node k and the node i are used as an example. The edge weight between the node k and the node i is 0.4, which is less than the weight threshold of 0.5, which may indicate that the degree of association between the user k corresponding to the node k and the user i corresponding to the node i is low. In this way, the user k and the user i may be divided into different communities. The node c and the node j are used as an example. In a case that there is no edge between the node c and the node j, and there is no jump probability from the node c to the node j or from the node j to the node c in Table 1, it may indicate that the degree of association between the node c and the node j is low, and the node c and the node j may be divided into different communities.

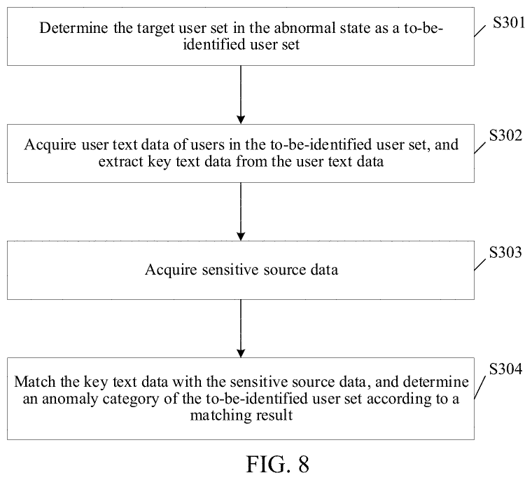

FIG. 8 is a diagram of a process for determining an anomaly category of a target user set in an abnormal state according to an embodiment. As shown in FIG. 8, the process may include the following operations:

In operation S301, the system determines the target user set in the abnormal state as a to-be-identified user set.

In operation S302, the system acquires user text data of users in the to-be-identified user set, and extracts key text data from the user text data.

In some embodiments, the user text data may be note information of a user during a transfer, conversation information of the user during a call, and the like. Keyword identification may be performed on the user text data to extract the key text data. For example, the note information of the user during the transfer is “gambling debt repayment”, so that a keyword “gambling debt” may be extracted.

In operation S303, the system acquires sensitive source data.

In some embodiments, the sensitive source data is a preset anomaly category set. The sensitive source data may include anomaly categories such as gambling, cashing, fraud, robbery, theft, and the like.

In operation S304, the system matches the key text data with the sensitive source data, and determines an anomaly category of the to-be-identified user set according to a matching result.

It can be learned from the above that, in the dividing the users having the social relationships into the target user set, in a case that the abnormal users in the target user set are determined and the target user set is in the abnormal state, the users having the social relationship with the abnormal user may be acquired from the target user set and are directly used as the diffusion-abnormal user without performing feature matching on each user. The identification of the diffusion-abnormal user can be performed by using the social relationship. Therefore, even if the diffusion-abnormal user has the same features as the normal user, the diffusion-abnormal user can still be identified because the diffusion-abnormal user has the social relationship with the abnormal user, thereby improving the accuracy of identification.

In some embodiments, the key text data may be matched with the sensitive source data. For example, the key text data is “gambling debt”, and after the key text data is matched with the sensitive source data, a matching ratio of “gambling debt” to “gambling” may reach 90%. In this way, the anomaly category of the to-be-identified user set may be determined as “gambling”.

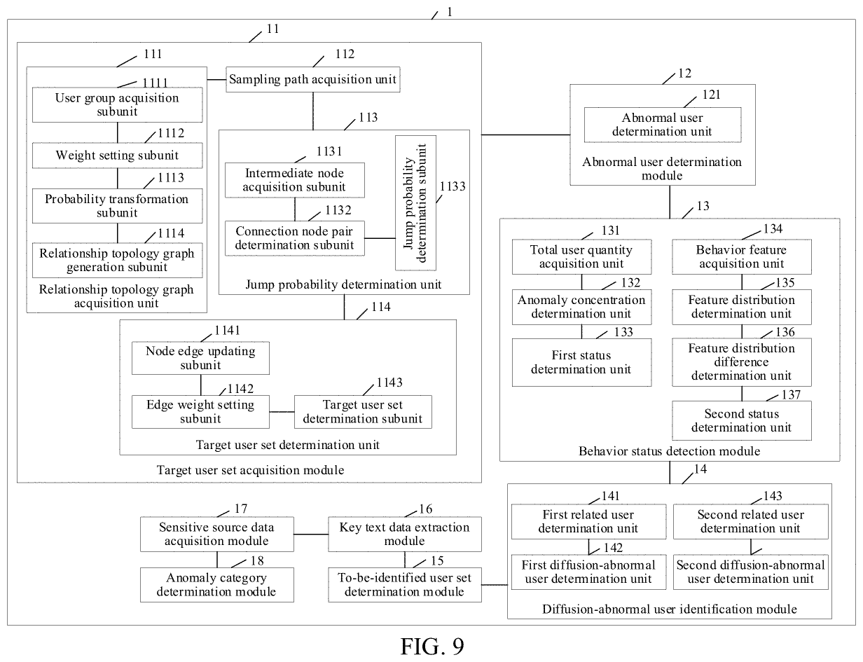

FIG. 9 is a structural diagram of a data identification apparatus according to an embodiment. The data identification apparatus may be a computer program (including program code) run on a computer device. For example, the data identification apparatus is application software, and the apparatus may be configured to perform the corresponding steps in the method provided in the embodiments of this disclosure. As shown in FIG. 9, a data identification apparatus 1 may include a target user set acquisition module 11, an abnormal user determination module 12, a behavior status detection module 13, and a diffusion-abnormal user identification module 14.

The target user set acquisition module 11 is configured to acquire a target user set. The target user set includes at least two users having a social relationship.

The abnormal user determination module 12 is configured to acquire a default abnormal user, and determine abnormal users in the target user set according to the default abnormal user.

The behavior status detection module 13 is configured to determine a status of the target user set according to the abnormal user.

The diffusion-abnormal user identification module 14 is configured to identify a diffusion-abnormal user from to-be-confirmed users according to social relationships between the abnormal users and the to-be-confirmed users in the target user set in a case that the status of the target user set is an abnormal state. The to-be-confirmed users are users in the target user set other than the abnormal users.

For the implementations of the target user set acquisition module 11, the abnormal user determination module 12, the behavior status detection module 13, and the diffusion-abnormal user identification module 14, for example, reference may be made to the descriptions of operation S101 to operation S104 in the embodiment corresponding to FIG. 3.

Referring to FIG. 9, the abnormal user determination module 12 may include an abnormal user determination unit 121.

The abnormal user determination unit 121 is configured to match the users in the target user set with the default abnormal user, and determine, as the abnormal users in the target user set, the users having a matching ratio in the target user set reaching a matching threshold.

For the implementation of the abnormal user determination unit 121, for example, reference may be made to the description of operation S102 in the embodiment corresponding to FIG. 4.

Referring to FIG. 9, the behavior status detection module 13 may include a total user quantity acquisition unit 131, an anomaly concentration determination unit 132, and a first status determination unit 133.

The total user quantity acquisition unit 131 is configured to acquire a quantity of the abnormal users, and acquire a total quantity of the users in the target user set.

The anomaly concentration determination unit 132 is configured to determine an anomaly concentration of the target user set according to the quantity of the abnormal users and the total quantity of the users in the target user set.

The first status determination unit 133 is configured to determine the status of the target user set as a normal state in a case that the anomaly concentration is less than a concentration threshold.

The first status determination unit 133 is further configured to determine the status of the target user set as an abnormal state in a case that the anomaly concentration is greater than or equal to the concentration threshold.

For the implementations of the total user quantity acquisition unit 131, the anomaly concentration determination unit 132, and the first status determination unit 133, for example, reference may be made to the description of operation S103 in the embodiment corresponding to FIG. 3.

Referring to FIG. 9, the behavior status detection module 13 may include a behavior feature acquisition unit 134, a feature distribution determination unit 135, a feature distribution difference determination unit 136, and a second status determination unit 137.

The behavior feature acquisition unit 134 is configured to acquire a user social behavior feature set. The user social behavior feature set includes a social behavior feature of each user in a user group.

The feature distribution determination unit 135 is configured to determine a first feature distribution of the abnormal users according to the social behavior features in the user social behavior feature set. The first feature distribution is used for representing a quantity of types of the social behavior features possessed by the abnormal users.

The feature distribution determination unit 135 is further configured to determine second feature distributions of the users in the target user set according to the social behavior features in the user social behavior feature set. The second feature distribution is used for representing a quantity of types of the social behavior features possessed by the users in the target user set.

The feature distribution difference determination unit 136 is configured to determine a feature distribution difference between the abnormal user and the users in the target user set according to the first feature distribution and the second feature distribution.

The second status determination unit 137 is configured to determine the status of the target user set according to the first feature distribution and the feature distribution difference.

The second status determination unit 137 is further configured to determine the status of the target user set as the normal state in a case that the feature distribution difference is less than a difference threshold and the first feature distribution is less than a distribution threshold.

The second status determination unit 137 is further configured to determine the status of the target user set as the normal state in a case that the feature distribution difference is greater than or equal to the difference threshold and the first feature distribution is greater than or equal to the distribution threshold.

The second status determination unit 137 is further configured to determine the status of the target user set as the abnormal state in a case that the feature distribution difference is greater than or equal to the difference threshold and the first feature distribution is less than the distribution threshold.

For the implementations of the behavior feature acquisition unit 134, the feature distribution determination unit 135, the feature distribution difference determination unit 136, and the second status determination unit 137, for example, reference may be made to the description of operation S103 in the embodiment corresponding to FIG. 3.

Referring to FIG. 9, the target user set acquisition module 11 may include a relationship topology graph acquisition unit 111, a sampling path acquisition unit 112, a jump probability determination unit 113, and a target user set determination unit 114.

The relationship topology graph acquisition unit 111 is configured to acquire a relationship topology graph corresponding to a user group. The relationship topology graph includes N nodes k. The N nodes k are in a one-to-one correspondence with users in the user group. N is a quantity of the users in the user group. An edge weight between two nodes k is determined based on a social relationship between two users in the user group.

The sampling path acquisition unit 112 is configured to acquire sampling paths corresponding to the nodes k from the relationship topology graph according to a quantity of sampling paths.

The jump probability determination unit 113 is configured to determine a jump probability between the node k and an association node in the sampling path according to the edge weight in the relationship topology graph. The association nodes are nodes in the sampling path other than the node k.

The target user set determination unit 114 is configured to update the relationship topology graph according to the jump probability to obtain an updated relationship topology graph, and determine the target user set from the updated relationship topology graph.

For the implementations of the relationship topology graph acquisition unit 111, the sampling path acquisition unit 112, the jump probability determination unit 113, and the target user set determination unit 114, for example, reference may be made to the description of operation S101 in the embodiment corresponding to FIG. 3.

Referring to FIG. 9, the relationship topology graph acquisition unit 111 may include a user group acquisition subunit 1111, a weight setting subunit 1112, a probability transformation subunit 1113, and a relationship topology graph generation subunit 1114.

The user group acquisition subunit 1111 is configured to acquire a user group. Each user in the user group is used as the node k.

The weight setting subunit 1112 is configured to perform an edge connection between the nodes k corresponding to the users having the social relationship, and set an initial weight for an edge between the nodes k according to social behavior records among the users having the social relationship.

The probability transformation subunit 1113 is configured to perform probability transformation on the initial weight to obtain the edge weight.

The relationship topology graph generation subunit 1114 is configured to generate the relationship topology graph according to the nodes k corresponding to the user group and the edge weight.

For the implementations of the user group acquisition subunit 1111, the weight setting subunit 1112, the probability transformation subunit 1113, and the relationship topology graph generation subunit 1114, for example, reference may be made to the description of operation S101 in the embodiment corresponding to FIG. 3.

Referring to FIG. 9, the jump probability determination unit 113 may include an intermediate node acquisition subunit 1131, a connection node pair determination subunit 1132, and a jump probability determination subunit 1133.

The intermediate node acquisition subunit 1131 is configured to acquire an intermediate node between the node k and the association node from the sampling path in a case that there is no edge between the node k and the association node. The node k reaches the association node through the intermediate node.

The connection node pair determination subunit 1132 is configured to use, as a connection node pair, two nodes in the node k, the intermediate node, and the association node having an edge, and acquire an edge weight corresponding to the connection node pair.

The jump probability determination subunit 1133 is configured to determine a jump probability between the node k and the association node according to the edge weight corresponding to the connection node pair.

For the implementations of the intermediate node acquisition subunit 1131, the connection node pair determination subunit 1132, and the jump probability determination subunit 1133, for example, reference may be made to the description of operation S101 in the embodiment corresponding to FIG. 3.

Referring to FIG. 9, the target user set determination unit 114 may include a node edge updating subunit 1141, an edge weight setting subunit 1142, and a target user set determination subunit 1143.

The node edge updating subunit 1141 is configured to update a connected edge in the relationship topology graph according to the node k and the association node, to obtain a transition relationship topology graph. The node k and the association node in the transition relationship topology graph are both connected with edges.

The edge weight setting subunit 1142 is configured to set, to an edge weight between the node k and the association node, the jump probability between the node k and the association node in the transition relationship topology graph, to obtain a target relationship topology graph.

The target user set determination subunit 1143 is configured to determine the target user set from the target relationship topology graph.

The target user set determination subunit 1143 is further configured to perform exponential growth on the jump probability, perform probability transformation on the jump probability obtained after the exponential growth, to obtain a target probability, and update the edge weight between the node k and the association node according to the target probability.

The target user set determination subunit 1143 is further configured to determine, as a vital association node of the node k, the association node having the updated edge weight greater than a weight threshold.

The target user set determination subunit 1143 is further configured to divide the target relationship topology graph into at least two community topology graphs according to the node k and the vital association node, and acquire a target community topology graph from the at least two community topology graphs as the target user set.

For the implementations of the node edge updating subunit 1141, the edge weight setting subunit 1142, and the target user set determination subunit 1143, for example, reference may be made to the description of operation S101 in the embodiment corresponding to FIG. 3.

Referring to FIG. 9, the diffusion-abnormal user identification module 14 may include a first related user determination unit 141 and a first diffusion-abnormal user determination unit 142.

The first related user determination unit 141 is configured to determine, from the to-be-confirmed users, the user having a social relationship with the abnormal user in a case that the status of the target user set is the abnormal state.

The first diffusion-abnormal user determination unit 142 is configured to determine, as the diffusion-abnormal user, the user having the social relationship with the abnormal user.

For the implementations of the first related user determination unit 141 and the first diffusion-abnormal user determination unit 142, for example, reference may be made to the description of operation S104 in the embodiment corresponding to FIG. 3.

Referring to FIG. 9, the diffusion-abnormal user identification module 14 may include a second related user determination unit 143 and a second diffusion-abnormal user determination unit 144.

The second related user determination unit 143 is configured to determine, from the to-be-confirmed users, the user having a social relationship with the abnormal user in a case that the status of the target user set is the abnormal state.

The second diffusion-abnormal user determination unit 144 is configured to acquire abnormal user nodes corresponding to the abnormal users, acquire association user nodes corresponding to the users having the social relationship with the abnormal user, determine, as a diffusion-abnormal node, the association user node having the edge weight with one of the abnormal user nodes greater than an association threshold, and determine the user corresponding to the diffusion-abnormal node as the diffusion-abnormal user.

For the implementations of the second related user determination unit 143 and the second diffusion-abnormal user determination unit 144, for example, reference may be made to the description of operation S104 in the embodiment corresponding to FIG. 3.

Referring to FIG. 9, the data identification apparatus 1 may include the target user set acquisition module 11, the abnormal user determination module 12, the behavior status detection module 13, and the diffusion-abnormal user identification module 14, and may further include a to-be-identified user set determination module 15, a key text data extraction module 16, a sensitive source data acquisition module 17, and an anomaly category determination module 18.

The to-be-identified user set determination module 15 is configured to determine the target user set in the abnormal state as a to-be-identified user set.

The key text data extraction module 16 is configured to acquire user text data of users in the to-be-identified user set, and extract key text data from the user text data.

The sensitive source data acquisition module 17 is configured to acquire sensitive source data.

The anomaly category determination module 18 is configured to match the key text data with the sensitive source data, and determine an anomaly category of the to-be-identified user set according to a matching result.

For the implementations of the to-be-identified user set determination module 15, the key text data extraction module 16, the sensitive source data acquisition module 17, and the anomaly category determination module 18, for example, reference may be made to the descriptions of operation S201 to operation S204 in the embodiment corresponding to FIG. 5.

According to the embodiments of this disclosure, the target user set is acquired, and the target user set includes at least two users having the social relationship. The default abnormal user is acquired, and the abnormal users in the target user set are determined according to the default abnormal user. The status of the target user set is determined according to the abnormal user. The diffusion-abnormal user is identified from the to-be-confirmed users according to the social relationships between the abnormal users and the to-be-confirmed users in the target user set in a case that the status of the target user set is an abnormal state. The to-be-confirmed users are users in the target user set other than the abnormal users. It can be learned from the above that, in the dividing the users having the social relationships into the target user set, in a case that the abnormal users in the target user set are determined and the target user set is in the abnormal state, the users having the social relationship with the abnormal user may be acquired from the target user set and are directly used as the diffusion-abnormal user without performing feature matching on each user. The identification of the diffusion-abnormal user can be performed by using the social relationship. Therefore, even if the diffusion-abnormal user has the same features as the normal user, the diffusion-abnormal user can still be identified because the diffusion-abnormal user has the social relationship with the abnormal user, thereby improving the accuracy of identification.

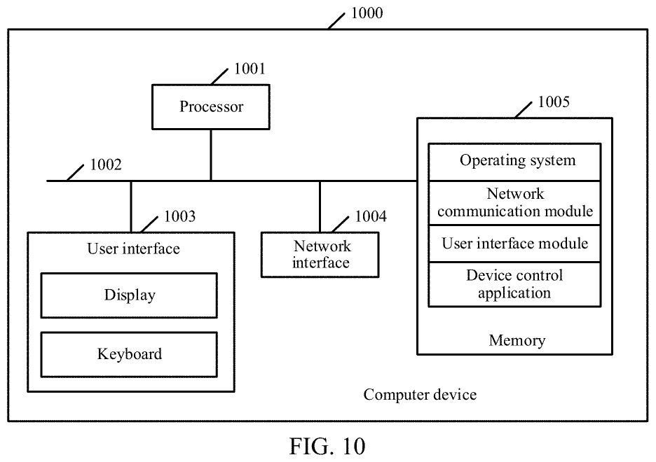

FIG. 10 is a diagram of a computer device according to an embodiment. As shown in FIG. 10, the apparatus 1 corresponding to the embodiment in FIG. 9 may be applied to the computer device 1000. The computer device 1000 may include: a processor 1001, a network interface 1004, and a memory 1005. In addition, the computer device 1000 may further include: a user interface 1003 and at least one communication bus 1002. The communication bus 1002 is configured to implement connection and communication between the components. The user interface 1003 may include a display, a keyboard, and optionally, the user interface 1003 may further include a standard wired interface and a standard wireless interface. In some embodiments, the network interface 1004 may include a standard wired interface or wireless interface (for example, a Wi-Fi interface). The memory 1005 may be a high-speed RAM memory, or may be a non-volatile memory, for example, at least one magnetic disk memory. The memory 1005 may alternatively be at least one storage apparatus located away from the processor 1001. As shown in FIG. 10, the memory 1005 used as a computer-readable storage medium may include an operating system, a network communication module, a user interface module, and a device-control application program.

In the computer device 1000 shown in FIG. 10, the network interface 1004 may be configured to provide a network communication function. The user interface 1003 is mainly configured to provide an input interface for a user. The processor 1001 may be configured to invoke the device-control application program stored in the memory 1005, to implement the following operations: acquiring a target user set, the target user set including at least two users having a social relationship; acquiring a default abnormal user, and determining abnormal users in the target user set according to the default abnormal user; determining a status of the target user set according to the abnormal user; and identifying a diffusion-abnormal user from to-be-confirmed users according to social relationship between the abnormal users and the to-be-confirmed users in the target user set in a case that the status of the target user set is an abnormal state, the to-be-confirmed users being users in the target user set other than the abnormal users.

It is to be understood that the computer device 1000 described in this embodiment of this disclosure can implement the descriptions of the video data processing method in the foregoing embodiment corresponding to FIG. 3 to FIG. 8, and can also implement the descriptions of the video data processing apparatus 1 in the foregoing embodiment corresponding to FIG. 9. In addition, the description of beneficial effects of the same method are not described herein again.

In addition, embodiments of this disclosure further provide a computer readable storage medium. The computer readable storage medium stores a computer program executed by the data processing computer device 1000 mentioned above, and the computer program includes program instructions. When executing the program instructions, the processor can perform the descriptions of the data processing method in the foregoing embodiments corresponding to FIG. 3 to FIG. 8. Therefore, details are not described herein again. In addition, the description of beneficial effects of the same method are not described herein again. For technical details that are not disclosed in the embodiments of the computer-readable storage medium of this disclosure, refer to the method embodiments of this disclosure.

The computer-readable storage medium may be the data identification apparatus according to any one of the foregoing embodiments or an internal storage unit of the foregoing computer device, for example, a hard disk or an internal memory of the computer device. The computer-readable storage medium may also be an external storage device, for example, a plug-in hard disk, a smart media card (SMC), a secure digital (SD) card, a flash card, and the like equipped on the computer device. Further, the computer-readable storage medium may further include both the internal storage unit and the external storage device of the computer device. The computer-readable storage medium is configured to store a computer program and other programs and data required by the computer device. The computer-readable storage medium may further be configured to temporarily store data that has been outputted or that is to be outputted.

In the specification, claims, and accompanying drawings of the embodiments of this disclosure, the terms “first” and “second” are intended to distinguish between different objects but do not indicate a particular order. In addition, the terms “include” and any variant thereof are intended to cover a non-exclusive inclusion. For example, a process, method, apparatus, product, or device that includes a series of steps or units is not limited to the listed steps or modules, but further optionally includes a step or module that is not listed, or further optionally includes another step or unit that is intrinsic to the process, method, apparatus product, or device.

A person of ordinary skill in the art may further realize that, in combination with the embodiments herein, units and algorithm, steps of each example described can be implemented with electronic hardware, computer software, or the combination thereof. In order to clearly describe the interchangeability between the hardware and the software, compositions and steps of each example have been generally described according to functions in the foregoing descriptions. Whether the functions are executed in a mode of hardware or software depends on particular applications and design constraint conditions of the technical solutions. A person skilled in the art may use different methods to implement the described functions for each particular application, but it is not to be considered that the implementation goes beyond the scope of this disclosure.

The method and the related apparatus provided in the embodiments of this disclosure are described with reference to the method flowcharts and/or schematic structural diagrams provided in the embodiments of this disclosure. For example, each flow and/or block in the method flowchart and/or schematic structural diagram and a combination of processes and/or blocks in the flowchart and/or block diagram may be implemented by computer program instructions. These computer program instructions may be provided to a general-purpose computer, a special-purpose computer, an embedded processor, or a processor of another programmable data processing device to generate a machine, so that an apparatus configured to implement functions specified in one or more procedures in the flowcharts and/or one or more blocks in the schematic structural diagrams is generated by using instructions executed by the general-purpose computer or the processor of another programmable data processing device. These computer program instructions may alternatively be stored in a computer-readable memory that can instruct a computer or another programmable data processing device to work in a specific manner, so that the instructions stored in the computer-readable memory generate an artifact that includes an instruction apparatus. The instruction apparatus implements a specific function in one or more procedures in the flowcharts and/or in one or more blocks in the schematic structural diagrams. These computer program instructions may also be loaded into a computer or another programmable data processing device, so that a series of operation steps are performed on the computer or another programmable data processing device to generate processing implemented by a computer, and instructions executed on the computer or another programmable data processing device provide steps for implementing functions specified in one or more procedures in the flowcharts and/or one or more blocks in the schematic structural diagrams.

According to the example embodiments, the target user set is acquired, and the target user set includes at least two users having the social relationship. The default abnormal user is acquired, and the abnormal users in the target user set are determined according to the default abnormal user. The status of the target user set is determined according to the abnormal user. The diffusion-abnormal user is identified from the to-be-confirmed users according to the social relationships between the abnormal users and the to-be-confirmed users in the target user set in a case that the status of the target user set is an abnormal state. The to-be-confirmed users are users in the target user set other than the abnormal users. According to example embodiments of the disclosure, in the dividing the users having the social relationships into the target user set, in a case that the abnormal users in the target user set are determined and the target user set is in the abnormal state, the users having the social relationship with the abnormal user may be acquired from the target user set and are directly used as the diffusion-abnormal user without performing feature matching on each user. The identification of the diffusion-abnormal user may be performed by using the social relationship. Therefore, even if the diffusion-abnormal user has features similar to the normal user, the diffusion-abnormal user may still be identified because the diffusion-abnormal user has the social relationship with the abnormal user, thereby improving the accuracy of identification.

What is disclosed above is merely exemplary embodiments of this disclosure, and is not intended to limit the scope of the claims of this disclosure. Therefore, equivalent variations made in accordance with the claims of this disclosure shall fall within the scope of this disclosure.

What is claimed is:

1. A method for data identification, performed by a computing device, the method comprising:
determining a target user set from a plurality of users, the target user set comprising at least two users having a first social relationship, wherein a first closeness of the first social relationship among the at least two users in the target user set is higher than a second closeness of a second social relationship between users in the target user set and a user not in the target user set;
acquiring a default abnormal user and determining abnormal users in the target user set based on the default abnormal user;
determining a status of the target user set based on the abnormal users in the target user set; and
identifying a diffusion-abnormal user from to-be-confirmed users based on social relationships between the abnormal users and the to-be-confirmed users in the target user set based on the status of the target user set being abnormal,
wherein the to-be-confirmed users comprise users in the target user set other than the abnormal users.

2. The method of claim 1, wherein the acquiring the default abnormal user and the determining the abnormal users in the target user set based on the default abnormal user comprises:
matching the users in the target user set with the default abnormal user, and
determining, as the abnormal users in the target user set, users having a matching ratio reaching a matching threshold.

3. The method of claim 1, wherein the determining the status of the target user set based on the abnormal users comprises:
acquiring a quantity of the abnormal users and acquiring a total quantity of the users in the target user set;
determining an anomaly concentration of the target user set according to the quantity of the abnormal users and the total quantity of the users in the target user set;
determining the status of the target user set as a normal state based on the anomaly concentration being less than a concentration threshold; and
determining the status of the target user set as abnormal based on the anomaly concentration being greater than or equal to the concentration threshold.

4. The method of claim 1, wherein the determining the status of the target user set based on the abnormal users comprises:
acquiring a user social behavior feature set, the user social behavior feature set comprising social behavior features of each user in a user group;
determining a first feature distribution of the abnormal users according to the social behavior features in the user social behavior feature set, the first feature distribution representing a quantity of types of the social behavior features possessed by the abnormal users;
determining a second feature distribution of the users in the target user set according to the social behavior features in the user social behavior feature set, the second feature distribution representing a quantity of types of the social behavior features possessed by the users in the target user set;
determining a feature distribution difference between the abnormal users and the users in the target user set based on the first feature distribution and the second feature distribution; and
determining the status of the target user set based on the feature distribution difference between the first feature distribution and the second feature distribution.

5. The method of claim 4, wherein the determining the status of the target user set based on the feature distribution difference between the first feature distribution and the second feature distribution comprises:
determining the status of the target user set as a normal state based on the feature distribution difference being less than a difference threshold and the first feature distribution being less than a distribution threshold;
determining the status of the target user set as the normal state based on the feature distribution difference being greater than or equal to the difference threshold and the first feature distribution being greater than or equal to the distribution threshold; and
determining the status of the target user set as abnormal based on the feature distribution difference being greater than or equal to the difference threshold and the first feature distribution being less than the distribution threshold.

6. The method of claim 1, wherein the determining the target user set from the plurality of users comprises:
dividing the plurality of users into at least two user sets based on collected social relationships and social behaviors among the plurality of users, such that a closeness of a social relationship among users in each user set is higher than a closeness of a social relationship among users in a different user set; and
selecting one of a plurality of user sets as the target user set.

7. The method of claim 6, wherein the dividing the plurality of users into the plurality of user sets comprises:
determining a relationship topology graph based on the social relationships and the social behaviors among the plurality of users, wherein, in the relationship topology graph, each node corresponds to one of the plurality of users, and an edge connecting two nodes indicates that the users corresponding to two nodes have a social relationship;
determining a closeness of the social relationship between two users based on the social relationships and the social behaviors among the plurality of users,
determining a weight of an edge between nodes corresponding to the two users based on the closeness of the social relationship between the two users;
dividing the relationship topology graph into at least two topology sub-graphs by using a clustering algorithm, and
selecting a set of users corresponding to nodes in one of the at least two topology sub-graphs as the target user set.

8. The method of claim 7, wherein the dividing the relationship topology graph into the at least two topology sub-graphs by using the clustering algorithm comprises:
acquiring a sampling path corresponding to a first node from the relationship topology graph based on a quantity of sampling paths;
determining a jump probability between the first node and an association node in the sampling path based on an edge weight in the relationship topology graph, the association node being a node in the sampling path other than the first node;
updating the relationship topology graph based on the jump probability to obtain an updated relationship topology graph, and
dividing the updated relationship topology graph to obtain the at least two topology sub-graphs.

9. The method of claim 7, wherein the determining the weight of the edge between the nodes corresponding to the two users based on the closeness of the social relationship between the two users comprises:
setting the closeness of the social relationship between the two users as an initial weight of the edge between the two nodes corresponding to the two users; and
performing probability transformation on the initial weight to obtain an edge weight.

10. The method of claim 8, wherein the determining the jump probability between the first node and the association node in the sampling path based on the edge weight in the relationship topology graph comprises:
acquiring an intermediate node between the first node and the association node from the sampling path in a case that there is no edge between the first node and the association node, the first node reaching the association node through the intermediate node;
selecting, as a connection node pair, two nodes in the first node, the intermediate node, and the association node having an edge,
acquiring an edge weight corresponding to the connection node pair; and
determining the jump probability between the first node and the association node based on the edge weight corresponding to the connection node pair.

11. The method of claim 8, wherein the updating the relationship topology graph based on the jump probability comprises:
updating a connected edge in the relationship topology graph based on the first node and the association node to obtain a transition relationship topology graph, the first node and the association node in the transition relationship topology graph being both connected with edges; and
setting the jump probability between the first node and the association node in the transition relationship topology graph as an edge weight between the first node and the association node to obtain the updated relationship topology graph.

12. The method of claim 8, wherein the dividing the updated relationship topology graph to obtain the at least two topology sub-graphs comprises:
performing exponential growth on the jump probability,
performing probability transformation on the jump probability obtained after the exponential growth to obtain a target probability,
updating the edge weight between the first node and the association node based on the target probability;
determining, as a vital association node of the first node, the association node having the updated edge weight greater than a weight threshold; and
dividing a target relationship topology graph into the at least two topology sub-graphs based on the first node and the vital association node.

13. The method of claim 1, wherein the identifying the diffusion-abnormal user from the to-be-confirmed users based on the social relationships between the abnormal users and the to-be-confirmed users in the target user set based on the status of the target user set being abnormal comprises:
determining users having the social relationships with the abnormal users from the to-be-confirmed users based on the status of the target user set being abnormal; and
determining, as the diffusion-abnormal user, the user having a social relationship with an abnormal user.

14. The method of claim 7, wherein the identifying the diffusion-abnormal user from the to-be-confirmed users based on the social relationships between the abnormal users and the to-be-confirmed users in the target user set based on the status of the target user set being abnormal comprises:
determining users having the social relationships with the abnormal users from the to-be-confirmed users based on the status of the target user set being abnormal;
acquiring abnormal user nodes corresponding to the abnormal users,
acquiring association user nodes corresponding to the users having the social relationship with the abnormal users,
determining, as a diffusion-abnormal node, an association user node having an edge weight with one of a number of abnormal user nodes greater than an association threshold, and determining a user corresponding to the diffusion-abnormal node as the diffusion-abnormal user.

15. The method of claim 1, further comprising:
determining the target user set as abnormal as a to-be-identified user set;
acquiring user text data of users in the to-be-identified user set, and extracting key text data from the user text data;
acquiring sensitive source data; and
matching the key text data with the sensitive source data, and determining an anomaly category of the to-be-identified user set based on a matching result.

16. A data identification apparatus, comprising:
at least one memory configured to store computer program code; and
at least one processor configured to access said computer program code and operate as instructed by said computer program code, said computer program code including:
first determining code configured to cause the at least one processor to determine a target user set from a plurality of users, the target user set comprising at least two users having a first social relationship, wherein a first closeness of the first social relationship among the at least two users in the target user set is higher than a second closeness of a second social relationship between users in the target user set and a user not in the target user set;
first acquiring code configured to cause the at least one processor to acquire a default abnormal user and determine abnormal users in the target user set based on the default abnormal user;
second determining code configured to cause the at least one processor to determine a status of the target user set based on the abnormal users; and
first identifying code configured to cause the at least one processor to identify a diffusion-abnormal user from to-be-confirmed users based on social relationships between the abnormal users and the to-be-confirmed users in the target user set based on the status of the target user set being abnormal,
wherein the to-be-confirmed users comprise users in the target user set other than the abnormal users.

17. The data identification apparatus of claim 16, wherein the first acquiring code is further configured to cause the at least one processor to:
match the users in the target user set with the default abnormal user, and
determine, as the abnormal users in the target user set, users having a matching ratio reaching a matching threshold.

18. The data identification apparatus of claim 16, wherein the second determining code is further configured to cause the at least one processor to:
acquire a quantity of the abnormal users and acquiring a total quantity of the users in the target user set;
determine an anomaly concentration of the target user set according to the quantity of the abnormal users and the total quantity of the users in the target user set;
determine the status of the target user set as a normal state based on the anomaly concentration being less than a concentration threshold; and
determine the status of the target user set as abnormal based on the anomaly concentration being greater than or equal to the concentration threshold.

19. The data identification apparatus of claim 16, wherein the second determining code is further configured to cause the at least one processor to:
acquire a user social behavior feature set, the user social behavior feature set comprising social behavior features of each user in a user group;
determine a first feature distribution of the abnormal users according to the social behavior features in the user social behavior feature set, the first feature distribution representing a quantity of types of the social behavior features possessed by the abnormal users;
determine a second feature distribution of the users in the target user set according to the social behavior features in the user social behavior feature set, the second feature distribution representing a quantity of types of the social behavior features possessed by the users in the target user set;
determine a feature distribution difference between the abnormal users and the users in the target user set based on the first feature distribution and the second feature distribution; and
determine the status of the target user set based on the feature distribution difference between the first feature distribution and the second feature distribution.

20. A non-transitory computer-readable storage medium storing computer instructions that, when executed by at least one processor of a device, cause the at least one processor to:
determine a target user set from a plurality of users, the target user set comprising at least two users having a first social relationship, wherein a first closeness of the first social relationship among the at least two users in the target user set is higher than a second closeness of a second social relationship between users in the target user set and a user not in the target user set;
acquire a default abnormal user and determine abnormal users in the target user set based on the default abnormal user;
determine a status of the target user set based on the abnormal users; and
identify a diffusion-abnormal user from to-be-confirmed users based on social relationships between the abnormal users and the to-be-confirmed users in the target user set based on the status of the target user set being abnormal,
wherein the to-be-confirmed users comprise users in the target user set other than the abnormal users.
